(19) United States
(12) Patent Application Publication
(10) Pub. No.: US 2026/0204006 A1
(43) Pub. Date: Jul. 16, 2026

(54) LIGHTING BAKING METHOD AND APPARATUS FOR VIRTUAL SCENE, COMPUTER DEVICE, AND STORAGE MEDIUM

(71) Applicant: Tencent Technology (Shenzhen) Company Limited, Shenzhen (CN)

(72) Inventors: Chao LI, Shenzhen (CN); Yuanheng LI, Shenzhen (CN); Zhenyu LIU, Shenzhen (CN); Zhigang CAI, Shenzhen (CN); Yu WU, Shenzhen (CN)

(21) Appl. No.: 19/562,410

(22) Filed: Mar. 10, 2026

Related U.S. Application Data
(63) Continuation of application No. PCT/CN2024/110157, filed on Aug. 6, 2024.

(30) Foreign Application Priority Data
Dec. 25, 2023 (CN) 202311811741.3

(51) Int. Cl. G06T 15/50

(52) U.S. Cl. CPC G06T 15/50

(57) ABSTRACT

This application relates to a lighting baking method for a virtual scene performed by a computer device. The method includes: obtaining scene elements in a virtual scene; performing scene division on the virtual scene, to obtain a scene tree structure; traversing spatial nodes in the scene tree structure based on a structural hierarchical relationship of the scene tree structure, to obtain a target node; determining, when the target node meets a baking condition, a baking element set based on scene elements of the target node, scene elements of an ancestor node of the target node, and scene elements of descendant nodes; and performing lighting baking on the baking element set, to obtain lighting information of the baking element set.

### CROSS-REFERENCE TO RELATED APPLICATIONS

This application is a continuation application of PCT Patent Application No. PCT/CN2024/110157, entitled “LIGHTING BAKING METHOD AND APPARATUS FOR VIRTUAL SCENE, COMPUTER DEVICE, AND STORAGE MEDIUM” filed on August 6, 2024, which claims priority to Chinese Patent Application No. 2023118117413, entitled "LIGHTING BAKING METHOD AND APPARATUS FOR VIRTUAL SCENE, COMPUTER DEVICE, AND STORAGE MEDIUM" filed on December 25, 2023, both of which are incorporated herein by reference in their entirety.

### FIELD OF THE TECHNOLOGY

This application relates to the field of computer technologies, and in particular, to a lighting baking method and apparatus for a virtual scene, a computer device, a storage medium, and a computer program product.

### BACKGROUND OF THE DISCLOSURE

With the development of computer technologies, users have increasingly higher requirements on image presentation effects of games.

In a game development process, because real lighting rendering consumes long time, lighting information of direct light sources and indirect light sources in a scene is usually calculated offline and stored, and the process is referred to as lighting baking. In a related technology, lighting baking on a virtual scene of a game is generally lighting baking on the entire virtual scene. However, the related technology can be used only for lighting baking on a small virtual scene. When a virtual scene is large, a data volume and a calculation amount related to lighting baking are large, and are limited by hardware resources, resulting in poor stability of lighting baking.

### SUMMARY

According to various embodiments provided in this application, a lighting baking method and apparatus for a virtual scene, a computer device, a computer-readable storage medium, and a computer program product are provided.

According to a first aspect, this application provides a lighting baking method for a virtual scene, performed by a computer device. The method includes:

obtaining scene elements in a virtual scene; performing scene division on the virtual scene based on the scene elements, to obtain a scene tree structure; traversing spatial nodes in the scene tree structure based on a structural hierarchical relationship, to obtain a target node; after determining that the target node meets a predetermined baking condition based on a quantity of elements of the target node and a quantity of elements of descendant nodes of the target node, determining a baking element set based on scene elements of the target node, scene elements of an ancestor node of the target node, and scene elements of the descendant nodes; and performing lighting baking on the baking element set, to obtain lighting information of the baking element set.

According to a second aspect, this application further provides a computer device, including a memory and one or more processors. The memory has computer-readable instructions stored therein. The computer-readable instructions, when executed by the one or more processors, cause the computer device to perform the following operations:

obtaining scene elements in a virtual scene; performing scene division on the virtual scene based on the scene elements, to obtain a scene tree structure; traversing spatial nodes in the scene tree structure based on a structural hierarchical relationship, to obtain a target node; after determining that the target node meets a predetermined baking condition based on a quantity of elements of the target node and a quantity of elements of descendant nodes of the target node, determining a baking element set based on scene elements of the target node, scene elements of an ancestor node of the target node, and scene elements of the descendant nodes; and performing lighting baking on the baking element set, to obtain lighting information of the baking element set.

According to a third aspect, this application further provides one or more non-transitory readable storage media, having computer-readable instructions stored therein. The computer-readable instructions, when executed by a processor of a computer device, cause the computer device to implement the following operations:

obtaining scene elements in a virtual scene; performing scene division on the virtual scene based on the scene elements, to obtain a scene tree structure; traversing spatial nodes in the scene tree structure based on a structural hierarchical relationship, to obtain a target node; after determining that the target node meets a predetermined baking condition based on a quantity of elements of the target node and a quantity of elements of descendant nodes of the target node, determining a baking element set based on scene elements of the target node, scene elements of an ancestor node of the target node, and scene elements of the descendant nodes; and performing lighting baking on the baking element set, to obtain lighting information of the baking element set.

obtaining scene elements in a virtual scene; performing scene division on the virtual scene based on the scene elements, to obtain a scene tree structure; traversing spatial nodes in the scene tree structure based on a structural hierarchical relationship, to obtain a target node; when it is determined, based on a quantity of elements of the target node and a quantity of elements of descendant nodes of the target node, that the target node meets a baking condition, determining a baking element set based on scene elements of the target node, scene elements of an ancestor node of the target node, and scene elements of the descendant nodes; and performing lighting baking on the baking element set, to obtain lighting information of the baking element set.

Details of one or more embodiments of this application are provided in the accompanying drawings and descriptions below. Other features, objectives, and advantages of this application become apparent from the specification, the accompanying drawings, and the claims.

### BRIEF DESCRIPTION OF THE DRAWINGS

To describe technical solutions in the embodiments of this application more clearly, the following briefly describes the drawings required for describing the embodiments. Apparently, the accompanying drawings described below are only exemplary embodiments of this application, and a person of ordinary skill in the art may further obtain other accompanying drawings according to the accompanying drawings without creative efforts.

FIG. 1 is a diagram of an application environment of a lighting baking method for a virtual scene according to an embodiment.

FIG. 2A is a schematic diagram of a lighting baking method for a virtual scene according to an embodiment.

FIG. 2B is a schematic flowchart of a lighting baking method for a virtual scene according to an embodiment.

FIG. 3 is a schematic diagram of scene elements of a virtual scene according to an embodiment.

FIG. 4 is a schematic diagram of a scene tree structure according to an embodiment.

FIG. 5 is a schematic flowchart of determining a baking element set according to an embodiment.

FIG. 6 is a schematic diagram of obtaining a baking element set based on location information of scene elements of an ancestor node according to an embodiment.

FIG. 7 is a schematic diagram of obtaining a baking element set based on location information of scene elements of an ancestor node according to another embodiment.

FIG. 8 is a schematic flowchart of obtaining a scene tree structure according to an embodiment.

FIG. 9 is a schematic diagram of a configuration interface for lighting baking according to an embodiment.

FIG. 10 is a schematic diagram of updating an initial scene tree structure according to an embodiment.

FIG. 11 is a schematic diagram of respectively storing lighting information based on preset sub-scenes according to an embodiment.

FIG. 12 is a schematic diagram of a scene in which lighting baking is performed on a virtual scene of an open-world game according to an embodiment.

FIG. 13 is a schematic diagram of comparison between an effect of performing lighting baking on an entire virtual scene and an effect of performing lighting baking by using a method according to an embodiment of this application.

FIG. 14 is a schematic flowchart of a lighting baking method for a virtual scene according to another embodiment.

FIG. 15 is a structural block diagram of a lighting baking apparatus for a virtual scene according to an embodiment.

FIG. 16 is a diagram of an internal structure of a computer device according to an embodiment.

### DESCRIPTION OF EMBODIMENTS

To make objectives, technical solutions, and advantages of this application clearer and more understandable, this application is further described in detail below with reference to the accompanying drawings and the embodiments. Specific embodiments described herein are only used to explain this application, and are not used to limit this application.

In the following descriptions, the included terms "first, second, and third" are merely intended to distinguish similar objects but do not necessarily indicate specific orders of objects. "First, second, and third" are interchangeable in terms of a specific order or sequence if permitted, so that the embodiments of this application described herein can be implemented in a sequence in addition to the sequence shown or described herein.

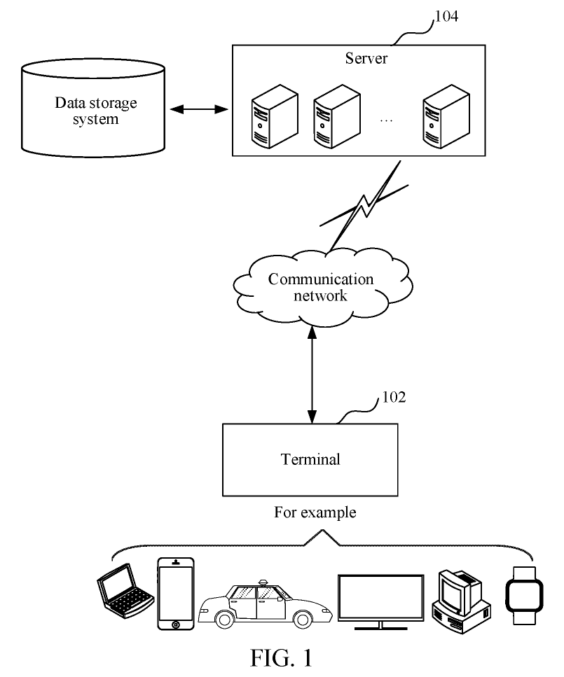

A lighting baking method for a virtual scene provided in the embodiments of this application may be applied to an application environment shown in FIG. 1.

A terminal 102 communicates with a server 104 through a network. A data storage system may store data that the server 104 needs to process. The data storage system may be integrated on the server 104, or may be placed on a cloud or another network server. The lighting baking method for a virtual scene may be performed by the terminal 102 or the server 104, or may be performed by the terminal 102 and the server 104 in cooperation.

By using an example in which the lighting baking method for a virtual scene is performed by the terminal 102, the terminal 102 may obtain scene elements in the virtual scene, where the scene elements include a scene object, a light mapping task, and a light probe task; the terminal 102 may perform scene division on the virtual scene based on the scene elements, to obtain a scene tree structure; the terminal 102 may traverse spatial nodes in the scene tree structure based on a structural hierarchical relationship, to obtain a target node; when it is determined, based on a quantity of elements of the target node and a quantity of elements of descendant nodes of the target node, that the target node meets a baking condition, the terminal 102 may determine a baking element set based on scene elements of the target node, scene elements of an ancestor node of the target node, and scene elements of the descendant nodes; the terminal 102 may perform lighting baking on the baking element set, to obtain lighting information of the baking element set; and the terminal 102 may further obtain lighting information of all scene elements in preset sub-scenes of the virtual scene based on the lighting information of the baking element set, and store the lighting information of all the scene elements in the preset sub-scenes.

The terminal 102 may be a smartphone, a tablet computer, a notebook computer, a desktop computer, a smart speaker, a smart watch, an Internet of Things device, or a portable wearable device. The Internet of Things device may be a smart speaker, a smart television, a smart air conditioner, a smart in-vehicle device, or the like. The portable wearable device may be a smart watch, a smart bracelet, a head-mounted device, or the like.

The server 104 may be an independent physical server, or may be a service node in a blockchain system. Service nodes in the blockchain system form a point-to-point network.

In addition, the server 104 may alternatively be a server cluster formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an artificial intelligence platform.

The terminal 102 may be connected to the server 104 in a communication connection manner like bluetooth, a universal serial bus (USB), or a network. This is not limited in this application herein.

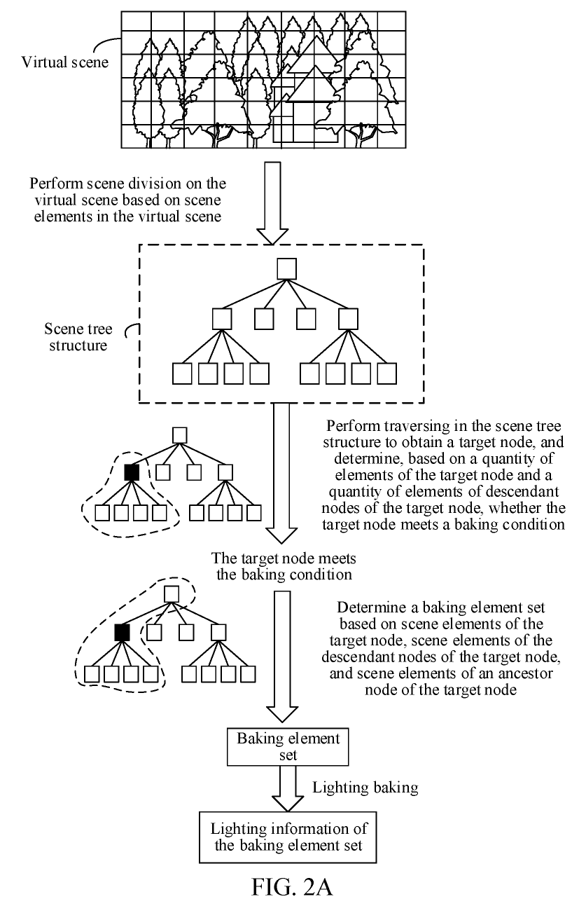

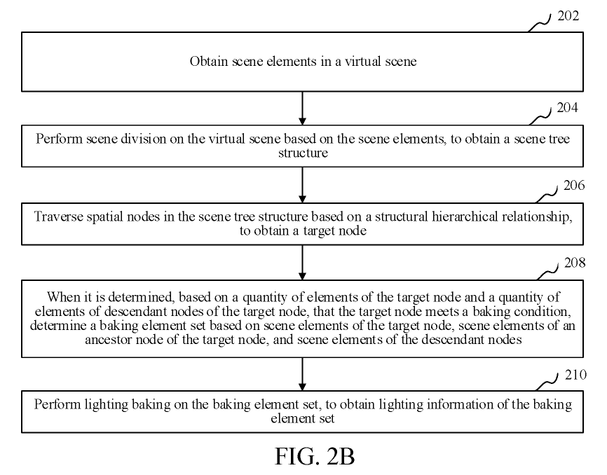

In some embodiments, as shown in FIG. 2A and FIG. 2B, a lighting baking method for a virtual scene is provided. An example in which the method is performed by a computer device is used for description. The computer device may be the server or the terminal in FIG. 1. The method includes the following operations:

Operation 202: Obtain scene elements in a virtual scene.

The virtual scene is a scene in a game application. When the computer device runs the game application, the computer device may display the virtual scene, and a virtual character in a game may perform activities in the virtual scene. The virtual scene is a scene obtained by simulating a real environment. For example, the virtual scene may include a virtual indoor environment, a virtual city scene, a virtual natural scene, or the like.

The game application may be an application running a linear game, or may be an application running an open-world game. Game levels of the linear game are sequentially expanded, and a player may complete the game levels based on a taskline. Game levels of the open-world game may be expanded at a selection of a player, and the player may freely perform activities in a virtual scene.

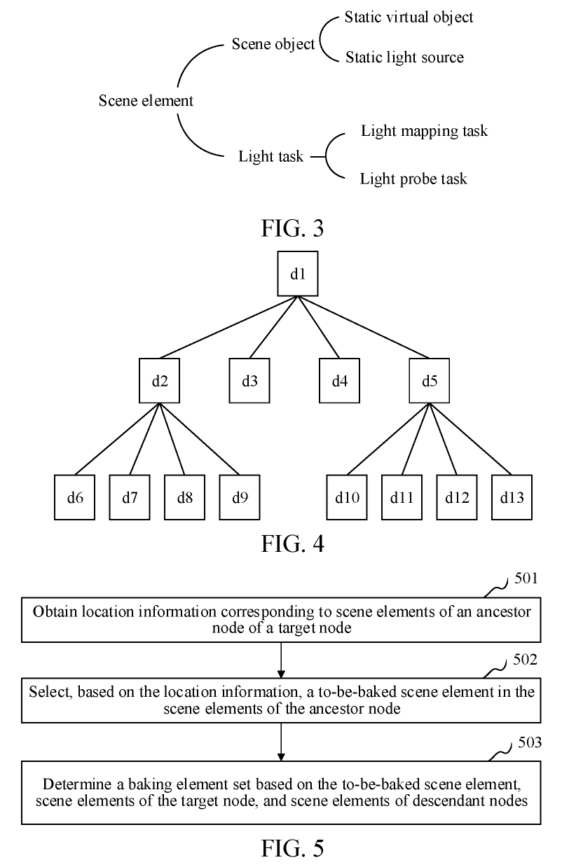

The scene elements are elements required for performing lighting baking on the virtual scene. As shown in FIG. 3, the scene elements in the virtual scene include a scene object and a light task. The scene object may be a static virtual object and a static light source in the virtual scene. The light task may be a light mapping task and a light probe task.

A virtual object is different from a real object. The virtual object is obtained by simulating a real object. The static virtual object is a virtual object having a fixed location in the virtual scene. For example, the static virtual object may be a house, a road sign, or the like in the virtual city scene (the virtual scene), or may be a mountain stone, a tree, or the like in the virtual natural scene (the virtual scene). The static light source is a light source having a fixed location in the virtual scene. For example, the static light source may be a candle, a desk lamp, or the like in the virtual indoor environment (the virtual scene), or may be a street lamp, a decorative light source of a house, or the like in the virtual city scene (the virtual scene).

The light mapping task may be understood as a task of determining lighting information corresponding to a blank light map. The blank light map may be associated with the scene object, indicating that the light mapping task is configured for determining lighting information of a surface of the scene object. The light mapping task is bound to the blank light map, and a spatial location of the blank light map in the virtual scene is a spatial location of the light mapping task in the virtual scene.

The lighting information of the surface of the scene object may be obtained through lighting baking, and the lighting information of the surface of the scene object is stored in the blank light map, to obtain a light map of the scene object in the virtual scene.

The light probe task may be understood as a task of calculating lighting information corresponding to a blank light probe. The blank light probe may be arranged at any spatial location in the virtual scene, indicating that the light probe task is configured for determining lighting information of the spatial location of the blank light probe. The light probe task is bound to the blank light probe, and the spatial location of the blank light probe in the virtual scene is a spatial location of the light probe task in the virtual scene. For example, the light probe task may be set around the scene object, set on the scene object, or uniformly set in the virtual scene. For example, light probe tasks may be uniformly set in the virtual scene based on a preset interval, or the light probe tasks may be uniformly set in some sub-scenes in the virtual scene based on a preset interval.

The lighting information of the spatial location of the light probe task may be obtained through lighting baking, and the lighting information of the spatial location of the light probe task is stored in the blank light probe, to obtain a light probe in the virtual scene.

In some embodiments, the scene object, the light mapping task, and the light probe task included in the scene elements are all preset in the virtual scene during game design. When the scene elements are set, spatial location information of the scene elements in the virtual scene is recorded. The computer device obtains the spatial location information of the scene elements in the virtual scene, and obtains the scene elements in the virtual scene based on the spatial location information of the scene elements. The scene elements in the virtual scene can be accurately obtained based on the preset spatial location information of the scene elements.

Operation 204: Perform scene division on the virtual scene based on the scene elements, to obtain a scene tree structure.

The scene tree structure is a tree structure, including a root node, an intermediate node, and leaf nodes. Each node in the scene tree structure corresponds to a spatial region in the virtual scene, and at least one node in the scene tree structure includes a scene element.

The scene tree structure may be a quadtree structure, an octree structure, or a hierarchical bounding box tree structure.

In some embodiments, the scene tree structure is the quadtree structure. The root node in the scene tree structure is generated based on the virtual scene, that is, a spatial region corresponding to the root node is the entire virtual scene. For each of the scene elements in the virtual scene, spatial location information of the scene element is obtained, and a volume of the scene element is determined based on the spatial location information of the scene element; when the volume of the scene element is smaller than one fourth of a volume of the spatial region corresponding to the root node, the root node is split into four sub-nodes, and a to-be-processed sub-node is determined in the four sub-nodes based on the spatial location information of the scene element; when the volume of the scene element is smaller than one fourth of a volume of a spatial region corresponding to the to-be-processed sub-node, the to-be-processed sub-node is continued to be split; and when the volume of the scene element is not smaller than one fourth of the volume of the spatial region corresponding to the to-be-processed sub-node, the to-be-processed sub-node is used as a to-be-processed sub-node corresponding to the scene element, and the scene element is added to the to-be-processed sub-node corresponding to the scene element. The foregoing process of adding the scene element to the to-be-processed sub-node is performed for each of the scene elements. After all the scene elements in the virtual scene are added to to-be-processed sub-nodes respectively corresponding to the scene elements, the scene tree structure is obtained. Scene division is performed based on a form of the quadtree structure, so that efficiency of constructing the scene tree structure can be improved. In this way, subsequently, when a baking element set is obtained from the scene tree structure of the quadtree structure, efficiency of obtaining the baking element set can also be improved.

The process of performing scene division on the virtual scene based on the scene elements to obtain the scene tree structure is a process in which layer-by-layer node splitting is performed based on the root node and a scene element is added to a node corresponding to the scene element in the layer-by-layer node splitting process, to gradually generate the scene tree structure of the virtual scene.

In some embodiments, the scene tree structure is the octree structure. The process of performing scene division on the virtual scene based on the scene elements to obtain the scene tree structure of the octree structure is similar to the foregoing process of obtaining the scene tree structure of the quadtree structure. A difference lies in that whether a volume of a scene element is smaller than one eighth of a volume of a spatial region corresponding to a node is determined. When the volume of the scene element is smaller than one eighth of the volume of the spatial region corresponding to the node, the node is split into eight sub-nodes. Therefore, for the process of performing scene division on the virtual scene based on the scene elements to obtain the scene tree structure of the octree structure, reference may be made to the foregoing process of obtaining the scene tree structure of the quadtree structure. Scene division is performed based on a form of the octree structure, so that the scene elements can be finely divided into sub-spaces of the virtual scene. In this way, subsequently, when a baking element set is obtained from the scene tree structure of the octree structure, a same scene element can be prevented from being repeatedly divided into different baking element sets, thereby improving accuracy of obtaining the baking element set.

In some embodiments, the scene tree structure is the hierarchical bounding box tree structure. A bounding box of each of the scene elements in the virtual scene is determined, and the root node in the scene tree structure is generated, where the root node indicates a bounding box surrounding the entire virtual scene. A center of the bounding box corresponding to the root node is used as a division limit, a bounding box of a scene element located on one side of the center is divided as one sub-node of the root node, and a bounding box of a scene element located on the other side of the center is divided as another sub-node of the root node. For each sub-node of the root node, a center of a bounding box corresponding to the sub-node is used as a division limit, and node splitting is performed on bounding boxes corresponding to scene elements included in the bounding box corresponding to the sub-node, until a bounding box corresponding to a sub-node obtained through splitting is a bounding box corresponding to a scene element, to obtain the scene tree structure. Scene division is performed based on a form of the hierarchical bounding box tree structure, so that the scene tree structure can be quickly constructed, thereby improving efficiency of constructing the scene tree structure. In this way, subsequently, when a baking element set is obtained from the scene tree structure of the hierarchical bounding box tree, a small calculation amount is involved, thereby improving efficiency of obtaining the baking element set.

Operation 206: Traverse spatial nodes in the scene tree structure based on a structural hierarchical relationship, to obtain a target node.

The structural hierarchical relationship is a hierarchical relationship between the spatial nodes in the scene tree structure. For example, in the scene tree structure, a hierarchy of an ancestor node is higher than a hierarchy of sub-nodes. The sub-nodes are obtained by node splitting on the ancestor node.

The traversing based on the structural hierarchical relationship may be traversing in descending order of hierarchies. For example, the root node is located at a first hierarchy, and sub-nodes of the root node are located at a second hierarchy. If the traversing is performed based on the structural hierarchical relationship, the root node is first traversed, and then the sub-nodes are traversed.

The target node is a spatial node in the scene tree structure, and a currently traversed spatial node is used as the target node.

In some embodiments, the computer device traverses the spatial nodes in the scene tree structure based on the structural hierarchical relationship, to obtain the target node, and performs layer-by-layer downward traversing from the root node based on the structural hierarchical relationship. To be specific, in a 1^{st} traversal round, the root node is used as a target node obtained through traversing. For another traversal round other than the 1^{st} traversal round, when there is a non-traversed spatial node belonging to the same hierarchy as a target node obtained in a previous traversal round, the non-traversed spatial node is traversed to obtain a target node; and when there is no non-traversed spatial node belonging to the same hierarchy as the target node obtained in the previous traversal round, sub-nodes of the target node obtained in the previous traversal round are traversed to obtain a target node. In this way, a target node is obtained through layer-by-layer downward traversing based on the structural hierarchical relationship, so that quantities of elements in target nodes and descendant nodes of the target nodes that are subsequently traversed also decrease downward layer by layer, to quickly obtain a baking element set conforming to a hardware processing capability.

For example, an example in which the scene tree structure is the quadtree structure is used for description. In a 1^{st} traversal round, the root node in the scene tree structure as a target node obtained through traversing. In a 2^{nd} traversal round, because there is no non-traversed spatial node belonging to the same hierarchy as the root node, sub-nodes of the root node are traversed to obtain a target node, for example, a 1^{st} sub-node of the root node in the scene tree structure is used as the target node obtained through traversing. In a 3^{rd} traversal round, because there is still a non-traversed spatial node belonging to the same hierarchy as the target node in the 2^{nd} traversal round, the non-traversed spatial node is traversed to obtain a target node, and a 2^{nd} sub-node of the root node in the scene tree structure is used as the target node obtained through traversing.

In some embodiments, the computer device obtains a current traversal round, and traverses spatial nodes in the scene tree structure based on the current traversal round, to obtain a target node. Specifically, each of the spatial nodes in the scene tree structure has a corresponding node number, where the node number is determined based on the structural hierarchical relationship. When the computer device traverses the spatial nodes based on the structural hierarchical relationship, the computer device may use a spatial node whose node number is consistent with that of the current traversal round as the target node. The target node is traversed based on a correspondence between the current traversal round and the node number, thereby improving efficiency of obtaining the target node through traversing.

For example, an example in which the scene tree structure is the quadtree structure is used for description. A node number of the root node is 1, node numbers of the four sub-nodes of the root node are 2, 3, 4, and 5, and node numbers of four sub-nodes of the spatial node whose node number is 2 are 6, 7, 8, and 9. By analogy, a node number of each of the spatial nodes in the scene tree structure may be determined. In the 1^{st} traversal round (the current traversal round is 1), the root node is the target node obtained through traversing. In the 2^{nd} traversal round (the current traversal round is 2), the spatial node whose node number is 2 is the target node obtained through traversing.

Operation 208: When it is determined, based on a quantity of elements of the target node and a quantity of elements of descendant nodes of the target node, that the target node meets a baking condition, determine a baking element set based on scene elements of the target node, scene elements of an ancestor node of the target node, and scene elements of the descendant nodes.

The quantity of elements of the target node is a total quantity of scene elements included in the target node. The scene element included in the target node is a scene element located in a spatial region corresponding to the target node in the virtual scene. The scene element may be a scene object and a light task. Therefore, the quantity of elements of the target node is a total quantity of scene objects and light tasks located in the spatial region corresponding to the target node in the virtual scene. For example, if the spatial region corresponding to the target node in the virtual scene includes a scene object A and a light mapping task of the scene object A, the quantity of elements of the target node is 2.

The descendant nodes of the target node include all spatial nodes in a sub-tree structure of the target node, and the sub-tree structure of the target node is, in the scene tree structure, a tree structure formed by spatial nodes obtained by performing node splitting based on the target node. For example, when the target node is the root node in the scene tree structure, the descendant nodes of the root node include all spatial nodes except the root node in the scene tree structure, and all the spatial nodes except the root node in the scene tree structure form the sub-tree structure of the target node.

The quantity of elements of the descendant nodes of the target node is a total quantity of scene elements included in all the spatial nodes in the sub-tree structure of the target node. Specifically, for each of the spatial nodes in the sub-tree structure of the target node, a total quantity of scene objects and light tasks located in a spatial region corresponding to the spatial node in the virtual scene is used as a quantity of elements of the spatial node. A sum of quantities of elements of all the spatial nodes in the sub-tree structure is the quantity of elements of descendant nodes of the target node.

For example, the target node has four sub-nodes, and two of the four sub-nodes each have four descendant nodes, so that the descendant nodes of the target node include 12 nodes. A total quantity of scene elements included in the 12 nodes is the quantity of elements of the descendant nodes of the target node.

The baking condition may be that a total quantity of the quantity of elements of the target node and the quantity of elements of the descendant nodes falls within a preset quantity interval. The total quantity that falls within the preset quantity interval is less than a total quantity that does not fall within the preset quantity interval.

Alternatively, the baking condition may be that a total quantity of the quantity of elements of the target node, the quantity of elements of the descendant nodes of the target node, and a quantity of elements of the ancestor node of the target node falls within the preset quantity interval.

The ancestor node of the target node includes a parent node of the target node and an ancestor node of the parent node. When the target node is not the root node in the scene tree structure, the ancestor node of the target node includes the root node. For example, if the target node is a spatial node at a third hierarchy in the scene tree structure, the ancestor node of the target node includes a parent node of the target node located at the second hierarchy and the root node located at the first hierarchy.

The baking element set may include the scene elements of the target node, the scene elements of the ancestor node of the target node, and the scene elements of the descendant nodes of the target node, or may include the scene elements of the target node, some scene elements of the ancestor node, and the scene elements of the descendant nodes.

Operation 208 is applicable to a case in which the scene tree structure is the quadtree structure or the octree structure. When the scene tree structure is the quadtree structure or the octree structure, scene elements included in all the spatial nodes in the scene tree structure form all scene elements in the virtual scene, that is, each spatial node in the scene tree structure includes some scene elements in the virtual scene. Therefore, a sum of the scene elements of the target node, the scene elements of the ancestor node of the target node, and the scene elements of the descendant nodes may be some scene elements in the virtual scene. The target node is obtained through traversing based on the structural hierarchical relationship. A lower hierarchy of the target node indicates a smaller quantity of descendant nodes of the target node, a smaller sum of the quantity of elements of the target node and the quantity of elements of the descendant nodes of the target node, and then a smaller quantity of scene elements in the baking element set. Therefore, performing traversing based on the structural hierarchical relationship to obtain the target node is to reduce a quantity of scene elements in the obtained baking element set, so that a quantity of scene elements participating in lighting baking once is smaller, thereby reducing a video memory occupation rate in a lighting baking process.

The computer device obtains the quantity of elements of the target node and the quantity of elements of the descendant nodes of the target node; and when it is determined, based on the quantity of elements of the target node and the quantity of elements of the descendant nodes of the target node, that the target node meets the baking condition, obtains the scene elements of the target node, the scene elements of the ancestor node of the target node, and the scene elements of the descendant nodes of the target node. The scene elements of the target node, the scene elements of the ancestor node of the target node, and the scene elements of the descendant nodes of the target node form the baking element set.

When the target node meets the baking condition, the scene elements of the ancestor node of the target node are obtained, and some scene elements whose center points belong to a spatial region corresponding to the target node are obtained in the scene elements of the ancestor node. The some scene elements obtained in the scene elements of the ancestor node, the scene elements of the target node, and the scene elements of the descendant nodes of the target node form the baking element set.

When the target node has no ancestor node, that is, when the target node is the root node in the scene tree structure, the baking element set is determined based on the scene elements of the target node and the scene elements of the descendant nodes of the target node.

When it is determined, based on the quantity of elements of the target node and the quantity of elements of the descendant nodes of the target node, that the target node does not meet the baking condition, the operation of traversing spatial nodes in the scene tree structure based on a structural hierarchical relationship, to obtain a target node is performed, until a target node obtained through traversing meets the baking condition, and the baking element set is determined based on the target node.

When the target node meets the baking condition, lighting baking is performed on the baking element set formed by the scene elements of the target node, the scene elements of the ancestor node, and the scene elements of the descendant nodes of the target node, so that the quantity of scene elements participating in lighting baking once falls within the preset quantity interval, that is, the quantity of scene elements participating in lighting baking once is smaller, thereby reducing the video memory occupation rate in the lighting baking process.

In some embodiments, when the scene tree structure is the hierarchical bounding box tree structure, after the target node is obtained by traversing the spatial nodes in the scene tree structure based on the structural hierarchical relationship, it is determined whether the quantity of elements of the target node falls within the preset quantity interval. If the quantity of elements of the target node falls within the preset quantity interval, it is determined that the target node meets the baking condition, and the baking element set is determined based on the scene element included in the target node. When the scene tree structure is the hierarchical bounding box tree structure, there is no need to determine, with reference to the descendant nodes of the target node, whether the target node meets the baking condition, and there is also no need to determine the baking element set based on the scene elements of the descendant nodes and the ancestor node of the target node, thereby improving efficiency of obtaining the baking element set.

When the scene tree structure is the hierarchical bounding box tree structure, the root node includes all scene elements in the virtual scene, a sum of scene elements included in sub-nodes of the root node is all the scene elements in the virtual scene, and a sum of scene elements included in all leaf nodes is also all the scene elements in the virtual scene. The target node is obtained by traversing the spatial nodes in the scene tree structure based on the structural hierarchical relationship. A lower hierarchy of the target node obtained through traversing indicates a smaller quantity of elements of the target node, and then a smaller quantity of scene elements in the baking element set. Therefore, performing traversing based on the structural hierarchical relationship to obtain the target node may reduce a quantity of scene elements in the obtained baking element set, so that a quantity of scene elements participating in lighting baking once is smaller, thereby reducing a video memory occupation rate in a lighting baking process.

When the target node meets the baking condition, the baking element set obtained based on the target node corresponds to the target node. After operation 206 is performed, operation 204 is performed, until all the scene elements in the scene tree structure exist in baking element sets. In this way, a baking element set corresponding to each target node meeting the baking condition can be obtained.

For example, all the scene elements in the scene tree structure are a scene element e1, a scene element e2, …, and a scene element en. When a target node d1 obtained through traversing meets the baking condition, a baking element set corresponding to the target node d1 includes: the scene element e1, the scene element e2, …, and a scene element ei. When a target node d2 obtained through traversing meets the baking condition, a baking element set corresponding to the target node d2 includes: a scene element ei+1, a scene element ei+2, …, and a scene element ej. When a target node d3 obtained through traversing meets the baking condition, a baking element set corresponding to the target node d3 includes: a scene element ej+1, a scene element ej+2, …, and the scene element en. A collection of the scene elements included in the baking element set corresponding to the target node d1, the baking element set corresponding to the target node d2, and the baking element set corresponding to the target node d3 is all the scene elements in the virtual scene.

Operation 210: Perform lighting baking on the baking element set, to obtain lighting information of the baking element set.

The lighting baking is a process of calculating lighting information of a surface of a scene object and lighting information of each spatial location in the virtual scene based on a light source setting and a scene object setting in the virtual scene. During actual application, lighting information of the virtual scene may be pre-calculated through lighting baking. During running of the game application, the virtual scene may be rendered based on the pre-calculated lighting information, to present a lighting effect of the virtual scene.

The baking element set includes at least one scene element, and the scene element may be a scene object, a light mapping task, and a light probe task.

The lighting information of the baking element set includes lighting information corresponding to the light mapping task and lighting information corresponding to the light probe task in the baking element set. The lighting information corresponding to the light mapping task is lighting information of a surface of the scene object associated with the light mapping task. To be specific, obtaining the lighting information corresponding to the light mapping task may be understood as obtaining a light map of the scene object associated with the light mapping task. The lighting information corresponding to the light probe task is lighting information of a spatial location of the light probe task in the virtual scene. To be specific, obtaining the lighting information corresponding to the light probe task may be understood as obtaining a light probe.

The scene object is associated with the light mapping task. When the baking element set includes the scene object and the associated light mapping task, performing lighting baking on the baking element set may be understood as a process of performing lighting calculation on the surface of the scene object based on the light mapping task to obtain the light map of the scene object.

The light probe task corresponds to the spatial location in the virtual scene. When the baking element set includes the light probe task, performing lighting baking on the baking element set may be understood as a process of performing lighting calculation on the spatial location corresponding to the light probe task in the virtual scene to obtain the light probe.

For example, a baking element set P1 includes a scene object A and a light mapping task m1 of the scene object A. Lighting baking is performed on the baking element set P1, so that lighting information of a surface of the scene object A may be calculated, to obtain a light map mapA of the scene object A. For another example, a baking element set P2 includes a light probe task b1 and a light probe task b2. Lighting baking is performed on the baking element set P2, so that lighting information of a spatial location of the light probe task b1 in the virtual scene may be calculated, that is, a light probe b1 is obtained; and lighting information of a spatial location of the light probe task b2 in the virtual scene may be calculated, that is, a light probe b2 is obtained.

When a plurality of target nodes meet the baking condition, correspondingly, a plurality of corresponding baking element sets may be obtained based on the plurality of target nodes.

In some embodiments, for the baking element sets corresponding to the target nodes meeting the baking condition, lighting baking is sequentially performed on the baking element sets, to sequentially obtain lighting information corresponding to a light mapping task and lighting information corresponding to a light probe task in each of the baking element sets. Each time the computer device performs lighting baking on one baking element set, the video memory occupation rate in the lighting baking process can be reduced.

After completing the lighting baking to obtain the lighting information, the computer device may store the lighting information. In a possible implementation, when obtaining lighting information of all baking element sets, that is, when obtaining the lighting information of the entire virtual scene, the computer device may store the lighting information of all the baking element sets to a local memory. In this way, subsequently, when lighting information of a scene element needs to be used, the lighting information may be obtained from the local memory. In this manner, integrity of the lighting information of the virtual scene can be ensured.

In another possible implementation, because the computer device performs lighting baking on one baking element set each time, each time the computer device obtains lighting information of one baking element set, the computer device may store the lighting information of the baking element set in a local memory. After lighting information of all baking element sets is stored in the local memory, the local memory stores the lighting information of the virtual scene, and needed lighting information may be obtained from the local memory. In this manner, the lighting information may be stored while lighting baking is performed, so that parallel processing of the lighting information may be implemented, thereby improving efficiency of storing the lighting information of the virtual scene.

In another possible implementation, each time the computer device obtains lighting information of one baking element set, the computer device obtains, from the lighting information of the baking element set, lighting information belonging to each of preset sub-scenes in the virtual scene. The virtual scene includes a plurality of preset sub-scenes. The virtual scene is the scene in the game application. The preset sub-scene may be understood as a scene corresponding to a level in the game.

When lighting information of all scene elements in a preset sub-scene is obtained, the lighting information of the preset sub-scene is stored. In this way, after lighting information of all the preset sub-scenes in the virtual scene is stored in the local memory, the local memory stores the lighting information of the virtual scene, and needed lighting information can be obtained from the local memory. In this manner, the lighting information may be stored while lighting baking is performed, so that parallel processing of the lighting information may be implemented, thereby improving efficiency of storing the lighting information of the virtual scene. In addition, the lighting information stored in the local memory is stored based on the preset sub-scenes in the virtual scene, and when lighting information of a preset sub-scene needs to be used, the lighting information of the preset sub-scene may be quickly obtained from the local memory. In a related technology, lighting baking is generally applied to a small virtual scene. When a virtual scene is large, a data volume and a calculation amount related to lighting baking are large, and have a high requirement on hardware resources of a computer device performing lighting baking. Consequently, it is difficult to ensure stability of lighting baking.

In the foregoing lighting baking method for a virtual scene, scene division is performed on scene elements in a virtual scene, to obtain a scene tree structure; a target node is obtained through traversing in the scene tree structure; when a quantity of elements of the target node and a quantity of elements of descendant nodes of the target node meet a baking condition, a baking element set is determined based on scene elements included in each of the target node and an ancestor node and the descendant nodes of the target node, so that a quantity of scene elements in the baking element set is smaller; and lighting baking is performed on the baking element set, so that a quantity of scene elements participating in lighting baking once is smaller. This can reduce a video memory occupation rate in a lighting baking process, and can improve stability of lighting baking.

In some embodiments, after the traversing spatial nodes in the scene tree structure based on a structural hierarchical relationship, to obtain a target node, the method further includes: obtaining the quantity of elements of the target node and the quantity of elements of the descendant nodes of the target node; performing summation processing on the quantity of elements of the target node and the quantity of elements of the descendant nodes, to obtain a total quantity of elements; and determining, when the total quantity of elements falls within a preset quantity interval, that the target node meets the baking condition. The preset quantity interval may be set to limit a quantity of object elements in the baking element set, that is, limit a quantity of scene elements sequentially participating in lighting baking, so that lighting baking can be applied to computer devices having different hardware resources, and stability of lighting baking can be ensured.

The total quantity of elements that falls within the preset quantity interval is less than a total quantity of elements that does not fall within the preset quantity interval. When lighting baking is performed, a larger total quantity of elements indicates more hardware resources required for lighting baking. Because the total quantity of elements that falls within the preset quantity interval is smaller, the quantity of scene elements participating in lighting baking can be limited by using the baking condition, thereby reducing hardware resources required for lighting baking.

The preset quantity interval may be determined according to a hardware resource status of the computer device performing lighting baking. For example, when the computer device has a low hardware calculation capability, the quantity in the preset quantity interval may be set to be small; and when the computer device has a high calculation capability, the quantity in the preset quantity interval may be set to be large. In this way, the baking element set can be obtained through adaptive division based on hardware resources of the computer device, so that lighting baking can be applied to computer devices having different hardware resources.

For the target node obtained through traversing, the computer device obtains a quantity of scene elements in the target node; obtains a quantity of scene elements of each of the descendant nodes of the target node; uses a sum of the quantity of scene elements of each of the descendant nodes as the quantity of elements of the descendant nodes of the target node; performs summation processing on the quantity of scene elements of the target node and the quantity of elements of the descendant nodes, to obtain the total quantity of elements; and determines, when the total quantity of elements falls within the preset quantity interval, that the target node meets the baking condition.

For example, the preset quantity interval is [1, 20], and the scene tree structure is shown in FIG. 4. When the target node obtained through traversing is d1, descendant nodes of the target node d1 include: a spatial node d2, a spatial node d3, a spatial node d4, a spatial node d5, a spatial node d6, a spatial node d7, a spatial node d8, a spatial node d9, a spatial node d10, a spatial node d11, a spatial node d12, and a spatial node d13. A quantity of elements of the target node d1 is 5, a quantity of elements of the descendant nodes of the target node d1 is 30, and a total quantity of elements is 35. Because the total quantity of elements being 35 does not fall within the preset quantity interval [1, 20], the target node d1 does not meet the baking condition.

When the target node obtained through traversing is d2, descendant nodes of the target node d2 include: the spatial node d6, the spatial node d7, the spatial node d8, and the spatial node d9. A quantity of elements of the target node d2 is 5, a quantity of elements of the descendant nodes of the target node d2 is 10, and a total quantity of elements is 15. Because the total quantity of elements being 10 falls within the preset quantity interval [1, 20], the target node d2 meets the baking condition.

In the foregoing embodiments, summation processing is performed on the quantity of elements of the target node and the quantity of elements of descendant nodes, to obtain the total quantity of elements. When the total quantity of elements falls within the preset quantity interval, it is determined that the target node meets the baking condition. The preset quantity interval may be set to limit a quantity of object elements in the baking element set, that is, limit a quantity of scene elements sequentially participating in lighting baking, so that lighting baking can be applied to computer devices having different hardware resources, and stability of lighting baking can be ensured.

In some embodiments, as shown in FIG. 5, the determining a baking element set based on scene elements of the target node, scene elements of an ancestor node of the target node, and scene elements of the descendant nodes includes the following operations: Operation 501: Obtain location information corresponding to the scene elements of the ancestor node of the target node. Operation 502: Select, based on the location information, a to-be-baked scene element in the scene elements of the ancestor node. Operation 503: Determine the baking element set based on the to-be-baked scene element, the scene elements of the target node, and the scene elements of the descendant nodes. In this way, the scene elements of the ancestor node may be divided into different baking element sets, to limit the quantity of scene elements in the baking element set, so that lighting baking can be applied to computer devices having different hardware resources, and stability of lighting baking can be ensured.

The location information corresponding to the scene elements may indicate locations of the scene elements in the virtual scene. In an implementation, the location information is location information of center points of the scene elements in the virtual scene. In another implementation, the location information may include location coordinates of vertexes of bounding boxes of the scene elements in the virtual scene.

The to-be-baked scene element may be a scene element that is some or all of the scene elements of the ancestor node and that corresponds to the target node. The baking element set includes the to-be-baked scene element, the scene elements of the target node, and the scene elements of the descendant nodes.

In some embodiments, the location information is the location information of the center points of the scene elements in the virtual scene. For each of the scene elements of the ancestor node, the computer device obtains location information of a center point of the scene element in the virtual scene; uses the scene element as the to-be-baked scene element corresponding to the target node if the location information is in the spatial region corresponding to the target node in the virtual scene; and combines the to-be-baked scene element, the scene elements of the target node, and the scene elements of the descendant nodes to obtain the baking element set. The to-be-baked scene element can be quickly determined based on a location relationship between the center point of the scene element and the spatial region corresponding to the target node in the virtual scene.

In some embodiments, the location information includes the location coordinates of the vertexes of the bounding boxes of the scene elements in the virtual scene. The computer device obtains the scene elements of the ancestor node of the target node. For each of the scene elements of the ancestor node, the computer device obtains location coordinates of vertexes of a bounding box of the scene element in the virtual scene; uses the scene element as the to-be-baked scene element if the location coordinates are all in the spatial region corresponding to the target node in the virtual scene, or uses the scene element as the to-be-baked scene element if at least half of the location coordinates are in the spatial region corresponding to the target node in the scene element; and combines the to-be-baked scene element, the scene elements of the target node, and the scene elements of the descendant nodes to obtain the baking element set. The to-be-baked scene element is determined based on a location relationship between the vertexes of the bounding box of the scene element and the spatial region corresponding to the target node in the virtual scene, to avoid dividing a same scene element into different baking element sets, thereby avoiding repeated baking of a light task, and improving efficiency of lighting baking.

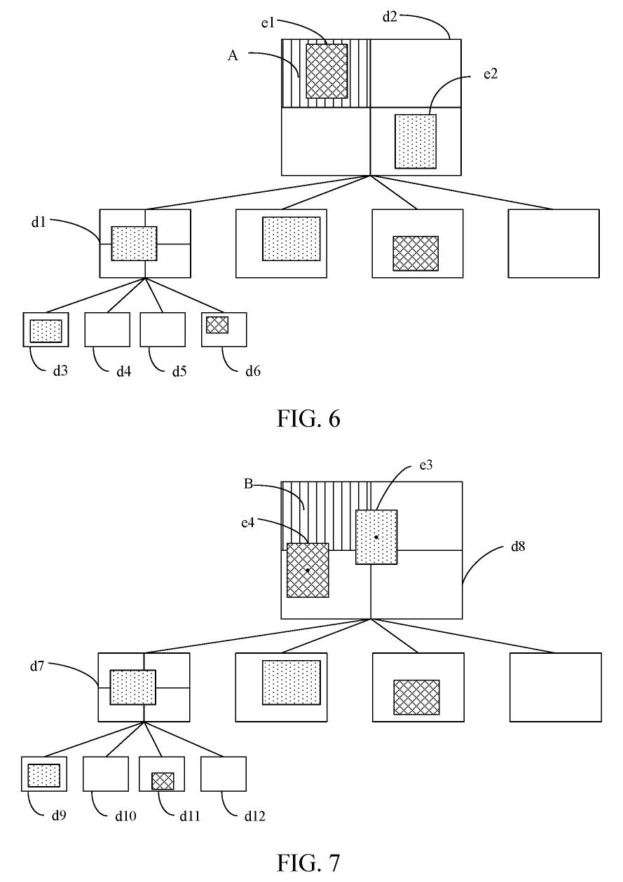

For example, as shown in FIG. 6, a target node d1 corresponds to a spatial region A in the virtual scene. For a scene element e1 of an ancestor node d2 of the target node d1, location coordinates of vertexes of a bounding box of the scene element e1 in the virtual scene are all in the spatial region A. In this case, the scene element e1 is used as the to-be-baked scene element. For a scene element e2 of the ancestor node d2 of the target node d1, location coordinates of vertexes of a bounding box of the scene element e2 in the virtual scene are not in the spatial region A. In this case, the scene element e2 is not the to-be-baked scene element. The baking element set includes: the scene element e1, scene elements of the target node d1, and scene elements of each of a sub-node d3, a sub-node d4, a sub-node d5, and a sub-node d6 of the target node d1. The sub-node d3, the sub-node d4, the sub-node d5, and the sub-node d6 are descendant nodes of the target node d1.

In the foregoing embodiments, based on the location information of the scene elements of an ancestor node, the to-be-baked scene element belonging to the baking element set corresponding to the target node is obtained in the scene elements of the ancestor node. In this way, the scene elements of the ancestor node may be divided into baking element sets corresponding to different target nodes, to avoid dividing all the scene elements of the ancestor node into a same baking element set, and limit the quantity of scene elements in the baking element set, so that lighting baking can be applied to computer devices having different hardware resources, and stability of lighting baking can be ensured.

In some embodiments, the obtaining location information corresponding to the scene elements of the ancestor node of the target node includes: traversing the scene elements of the ancestor node of the target node to obtain a target scene element; and obtaining location information of a center point of the target scene element in the virtual scene; and the selecting, based on the location information, a to-be-baked scene element in the scene elements of the ancestor node includes: using the target scene element as the to-be-baked scene element when the location information belongs to a node space of the target node. Whether the target scene element is the to-be-baked scene element is determined based on a location relationship between the center point of the target scene element and the node space of the target node, to reduce a quantity of pieces of location information involved in selecting the to-be-baked scene element, thereby improving efficiency of selecting the to-be-baked scene element.

The location information is location coordinates of the center point of the target scene element in the virtual scene. The node space of the target node indicates the spatial region corresponding to the target node in the virtual scene.

The computer device obtains the scene elements of the ancestor node of the target node, and traverses the scene elements to obtain the target scene element. The computer device obtains the location information of the center point of the target scene element in the virtual scene; obtains location information of the spatial region corresponding to the node space of the target node in the virtual scene; determines, based on the location information of the center point in the virtual scene and the location information of the spatial region corresponding to the node space in the virtual scene, whether the center point of the target scene element is located in the node space of the target node; and uses the target scene element as the to-be-baked scene element if the center point of the target scene element is located in the node space of the target node. When the center point of the target scene element is located in the node space of the target node, it indicates that most content of the target scene element is located in the node space of the target node. Therefore, the target scene element may be used as the to-be-baked scene element in the baking element set corresponding to the target node.

For example, as shown in FIG. 6, a target node d1 corresponds to a spatial region A in the virtual scene. For a scene element e1 of an ancestor node d1 of the target node d1, location information of a center point of the scene element e1 is in the spatial region A. In this case, the scene element e1 is used as the to-be-baked scene element. For a scene element e2 of the ancestor node d1 of the target node d1, location information of a center point of the scene element e2 is not in the spatial region A. In this case, the scene element e2 is not the to-be-baked scene element. The baking element set includes: the scene element e1, scene elements of the target node d1, and scene elements of each of a sub-node d3, a sub-node d4, a sub-node d5, and a sub-node d6 of the target node d1. The sub-node d3, the sub-node d4, the sub-node d5, and the sub-node d6 are descendant nodes of the target node d1.

In the foregoing embodiments, whether the target scene element is the to-be-baked scene element is determined based on the location relationship between the center point of the target scene element and the node space of the target node, to reduce the quantity of pieces of location information involved in selecting the to-be-baked scene element, thereby reducing a calculation amount required in selecting the to-be-baked scene element, and improving the efficiency of selecting the to-be-baked scene element.

In some embodiments, the lighting baking method for a virtual scene further includes: obtaining the location information corresponding to the scene elements of the ancestor node of the target node; and the determining a baking element set based on scene elements of the target node, scene elements of an ancestor node of the target node, and scene elements of the descendant nodes includes: determining, when no to-be-baked scene element is selected in the scene elements of the ancestor node based on the location information, the baking element set based on the scene elements of the target node and the scene elements of the descendant nodes. The baking element set does not include the scene elements of the ancestor node, to limit the quantity of scene elements in the baking element set, so that lighting baking can be applied to computer devices having different hardware resources, and stability of lighting baking can be ensured.

The location information corresponding to the scene elements of the ancestor node may include location coordinates of center points of the scene elements in the virtual scene, or may include location coordinates of vertexes of bounding boxes of the scene elements in the virtual scene.

When no to-be-baked scene element is selected in the scene elements of the ancestor node based on the location information, the baking element set includes the scene elements of the target node and the scene elements of the descendant nodes.

A process of obtaining the location information corresponding to the scene elements of the ancestor node of the target node is the same as the process of obtaining the location information corresponding to the scene elements of the ancestor node of the target node in the foregoing embodiments. Therefore, reference may be made to the descriptions for obtaining the location information corresponding to the scene elements of the ancestor node of the target node in the foregoing embodiments.

The location information may be the location information of the center points of the scene elements in the virtual scene. For each of the scene elements of the ancestor node, the computer device obtains location information of a center point of the scene element in the virtual scene. If the location information does not belong to the node space of the target node, the scene element is not the to-be-baked scene element of the target node. If the location information of the center point of each of the scene elements in the ancestor node does not belong to the node space of the target node, it indicates that no to-be-baked scene element is selected in the scene elements of the ancestor node based on the location information. In this way, the baking element set includes the scene elements of the target node and the scene elements of the descendant nodes.

The location information may alternatively include the location coordinates of the vertexes of the bounding boxes of the scene elements in the virtual scene. For each of the scene elements of the ancestor node, the computer device obtains location coordinates of vertexes of a bounding box of the scene element in the virtual scene. If all the location coordinates are not in the spatial region corresponding to the target node in the virtual scene, the scene element is not the to-be-baked scene element of the target node. If each of the scene elements in the ancestor node is not the to-be-baked scene element of the target node, it indicates that no to-be-baked scene element is selected in the scene elements of the ancestor node based on the location information. In this way, the baking element set includes the scene elements of the target node and the scene elements of the descendant nodes.

For example, as shown in FIG. 7, a target node d7 corresponds to a spatial region B in the virtual scene. For a scene element e3 of an ancestor node d8 of the target node d7, location information of a center point of the scene element e3 is not in the spatial region B. In this case, the scene element e3 is not the to-be-baked scene element. For a scene element e4 of the ancestor node d8, location information of a center point of the scene element e4 is not in the spatial region B. In this case, the scene element e4 is not the to-be-baked scene element, all the scene elements (e3 and e4) of the ancestor node d8 are not the to-be-baked scene element. In this case, the baking element set includes: scene elements of the target node d7, and scene elements of each of a sub-node d9, a sub-node d10, a sub-node d11, and a sub-node d12 of the target node d7. The sub-node d9, the sub-node d10, the sub-node d11, and the sub-node d12 are descendant nodes of the target node d1.

In the foregoing embodiments, when no to-be-baked scene element is selected in the scene elements of the ancestor node, the baking element set is determined based on the scene elements of the target node and the scene elements of the descendant nodes, to limit the quantity of scene elements in the baking element set, so that lighting baking can be applied to computer devices having different hardware resources, and stability of lighting baking can be ensured.

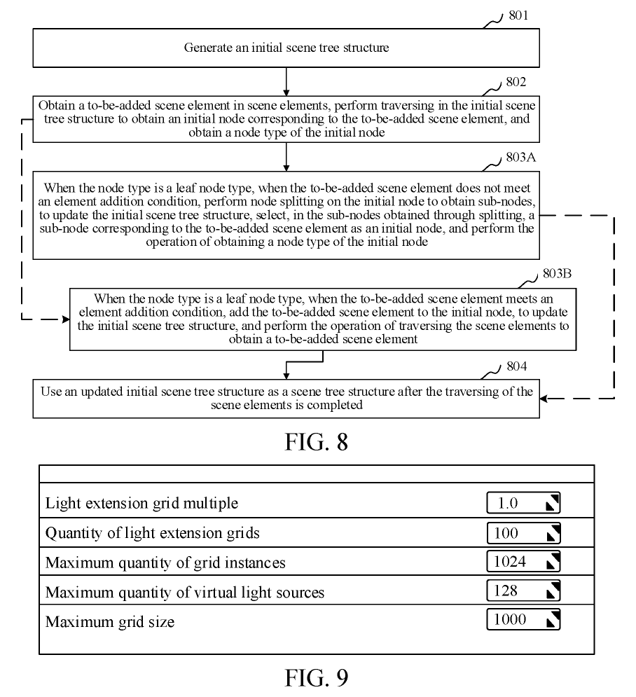

In some embodiments, as shown in FIG. 8, the performing scene division on the virtual scene based on the scene elements, to obtain a scene tree structure includes the following operations: Operation 801: Generate an initial scene tree structure. Operation 802: Obtain a to-be-added scene element in the scene elements, perform traversing in the initial scene tree structure to obtain an initial node corresponding to the to-be-added scene element, and obtain a node type of the initial node. Operation 803A: When the node type is a leaf node type, when the to-be-added scene element does not meet an element addition condition, perform node splitting on the initial node to obtain sub-nodes, to update the initial scene tree structure, select, in the sub-nodes obtained through splitting, a sub-node corresponding to the to-be-added scene element as an initial node, and perform the operation of obtaining a node type of the initial node. Operation 803B: When the node type is a leaf node type, when the to-be-added scene element meets an element addition condition, add the to-be-added scene element to the initial node, to update the initial scene tree structure, and perform the operation of traversing the scene elements to obtain a to-be-added scene element. Operation 804: Use an updated initial scene tree structure as the scene tree structure after the traversing of the scene elements is completed. Based on the scene tree structure, the scene elements are finely divided into the sub-spaces of the virtual scene. In this way, subsequently, when the baking element set for lighting baking is obtained based on the scene tree structure, a same scene element can be prevented from being repeatedly divided into different baking element sets, thereby reducing a repeated baking task during lighting baking, saving hardware resources, and improving efficiency of lighting baking.

The generated initial scene tree structure includes a root node, which may be understood as generating a root node corresponding to the virtual scene and using the root node as the initial scene tree structure. The to-be-added scene element is one of the scene elements in the virtual scene.

Performing scene division on the virtual scene based on the scene elements to obtain the scene tree structure refers to performing node splitting on a node in the initial scene tree structure; and adding, in the node splitting process, a scene element to the node in the initial scene tree structure, to obtain the scene tree structure. Adding one scene element to the node in the initial scene tree structure may involve a process of node splitting for a plurality of times, updating the initial node for a plurality of times, and updating the initial scene tree structure for a plurality of times.

The node type of the initial node is a node type of the initial node in a current initial scene tree structure, and the node type is the leaf node type or not the leaf node type. When the node type of the initial node is the leaf node type, it indicates that the initial node is a leaf node in the current initial scene tree structure, or it indicates that the initial node has no sub-node in the current initial scene tree structure.

When a 1^{st} to-be-added scene element is added to the initial scene tree structure, an initial node obtained for the first time is a root node. Because the root node included in the current initial scene tree structure has no sub-node, the node type of the initial node is the leaf node type.

The element addition condition is a condition for adding the to-be-added scene element to the initial node, and whether the to-be-added scene element meets the element addition condition may be determined based on the initial node. For example, the element addition condition may be that a space corresponding to the to-be-added scene element in the virtual scene occupies a preset percentage of a space corresponding to the initial node in the virtual scene. Alternatively, the element addition condition may be that when an element type of the to-be-added scene element is a first type, the space corresponding to the to-be-added scene element in the virtual scene occupies a first preset percentage of the space corresponding to the initial node in the virtual scene. Alternatively, the element addition condition may be that when the element type of the to-be-added scene element is a second type, the space corresponding to the to-be-added scene element in the virtual scene occupies a second preset percentage of the space corresponding to the initial node in the virtual scene.

When the element type of the to-be-added scene element is the first type, it indicates that the to-be-added scene element is a scene object. When the element type of the to-be-added scene element is the second type, it indicates that the to-be-added scene element is a light mapping task or a light probe task.

In the foregoing example, specific values of the preset percentage, the first preset percentage, and the second preset percentage may all be set according to requirements. This is not limited in the embodiments of this application.

When the scene tree structure is a quadtree structure, four sub-nodes may be obtained by performing node splitting on the initial node. When the scene tree structure is an octree structure, eight sub-nodes may be obtained by performing node splitting on the initial node.

The computer device generates the root node corresponding to the virtual scene, and uses the root node as the initial scene tree structure; and traverses the scene elements in the virtual scene to obtain the to-be-added scene element, uses the root node as the initial node, and obtains the node type of the initial node as the leaf node type.

The computer device determines, based on the initial node, whether the to-be-added scene element meets the element addition condition; and when the to-be-added scene element does not meet the element addition condition, performs node splitting on the initial node to obtain the sub-nodes, to update the initial scene tree structure, where the updated initial scene tree structure includes the initial node and the sub-nodes obtained by splitting the initial node, and selects, in the sub-nodes obtained through splitting, the sub-node corresponding to the to-be-added scene element as the initial node, that is, replaces the initial node with the sub-node corresponding to the to-be-added scene element. The sub-node corresponding to the to-be-added scene element is a sub-node including the to-be-added scene element in a corresponding spatial region in the virtual scene.

For ease of description, the initial node before node splitting is performed is recorded as a first initial node, and the sub-node corresponding to the to-be-added scene element is recorded as a second initial node. After the second initial node is selected, the operation of obtaining a node type of the initial node is performed. Because the second initial node is obtained by performing node splitting on the first initial node and the second initial node has no sub-node, the type of the second initial node is the leaf node type. The computer device determines, based on the second initial node, whether the to-be-added scene element meets the element addition condition; and adds, when the to-be-added scene element meets the element addition condition, the to-be-added scene element to the second initial node, to update the initial scene tree structure, and performs the operation of traversing the scene elements to obtain a to-be-added scene element, to add a next to-be-added scene element obtained through traversing to an initial node. Similarly, adding the next to-be-added scene element obtained through traversing to the initial node may involve a process of node splitting for a plurality of times, updating the initial node for a plurality of times, and updating the initial scene tree structure for a plurality of times. After traversing of all the scene elements in the virtual scene is completed, that is, after all the scene elements are added to initial nodes, the updated initial scene tree structure is used as the scene tree structure.

In some embodiments, because lighting of a scene element may be affected by surrounding scene elements, for example, blocking or a rebound occurs, the scene element may be extended, to prevent the lighting of the scene element from being affected by the surrounding scene elements. The computer device extends the scene elements, and updates the scene elements by using extended scene elements.

Extending the scene elements includes extending the scene object, the light mapping task, and the light probe task. Specifically, the computer device may obtain a bounding box of the scene object, and extend the bounding box of the scene object based on a light extension coefficient, to obtain an extended scene object; obtain the light mapping task, and extend the light mapping task based on the light extension coefficient, to obtain an extended light mapping task; and obtain the light probe task, and extend the light probe task based on the light extension coefficient, to obtain an extended light probe task.

The light extension coefficient may be a quantity of light extension grids, or may be a light extension grid multiple. A grid is a unit measuring a size of a space occupied by a scene element in the virtual scene. An example in which the scene object is extended is used for description. Extending the bounding box of the scene object based on the light extension coefficient may be extending a length and a width of the bounding box of the scene object based on the quantity of light extension grids or the light extension grid multiple.

Extending the length and the width of the bounding box of the scene object based on the quantity of light extension grids may be increasing the length and the width of the bounding box of the scene object by the quantity of the light extension grids. Extending the length and the width of the bounding box of the scene object based on the light extension grid multiple may be multiplying the length and the width of the bounding box of the scene object by the light extension grid multiple.

For example, the computer device may set the light extension coefficient on a configuration interface for lighting baking. The configuration interface for lighting baking is shown in FIG. 9. A light extension grid multiple is 1, and a quantity of light extension grids is 100. The length and the width of the bounding box of the scene object each are 2000 grids, the quantity of light extension grids is 100, and a length and a width of a bounding box of an extended scene object each are 2100 grids.

In some embodiments, the scene tree structure is the quadtree structure. The computer device uses a horizontal plane of the virtual scene as a scene division plane, and performs scene division on the virtual scene based on the scene division plane, where the horizontal plane of the virtual scene is a plane formed by an X direction axis and a Y direction axis for creating the virtual scene; and determines the bounding box of the scene object, the light mapping task, and the light probe task in the scene division plane, and performs scene division on the virtual scene based on the bounding box of the scene object, the light mapping task, and the light probe task in the scene division plane, to obtain the scene tree structure of a quadtree. Scene division is performed based on a form of the quadtree structure, so that efficiency of constructing the scene tree structure can be improved. In this way, subsequently, when a baking element set is obtained from the scene tree structure of the quadtree structure, efficiency of obtaining the baking element set can also be improved.

In some embodiments, the scene tree structure is the octree structure. The computer device performs scene division on a space corresponding to the virtual scene based on the scene elements in the virtual scene, where the space corresponding to the virtual scene is a space formed by an X direction axis, a Y direction axis, and a Z direction axis for creating the virtual scene; and determines the bounding box of the scene object, the light mapping task, and the light probe task in the space corresponding to the virtual scene, and performs scene division on the bounding box of the scene object, the light mapping task, and the light probe task in the space corresponding to the virtual scene, to obtain the scene tree structure of an octree. Scene division is performed based on a form of the octree structure, so that the scene elements can be finely divided into sub-spaces of the virtual scene. In this way, subsequently, when a baking element set is obtained from the scene tree structure of the octree structure, a same scene element can be prevented from being repeatedly divided into different baking element sets, thereby improving accuracy of obtaining the baking element set.

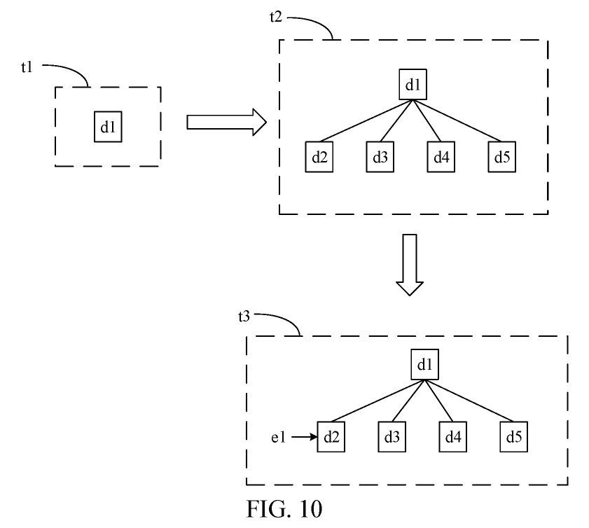

An example in which a to-be-added scene element obtained through traversing for the first time is added to the initial node when the scene tree structure is the quadtree structure is used for description. As shown in FIG. 10, an initial scene tree structure t1 is generated, where the initial scene tree structure t1 includes a root node d1. After a to-be-added scene element e1 is obtained through traversing, the root node d1 is used as an initial node. A node type of the initial node d1 is a leaf node type. Whether the to-be-added scene element e1 meets an element addition condition is determined based on the initial node d1. When the to-be-added scene element e1 does not meet the element addition condition, node splitting is performed on the initial node d1, to obtain a sub-node d2, a sub-node d3, a sub-node d4, and a sub-node d5, to update the initial scene tree structure t1 to an initial scene tree structure t2. The sub-node d2 corresponding to the to-be-added scene element e1 is selected in the sub-node d2, the sub-node d3, the sub-node d4, and the sub-node d5, the sub-node d2 is used as an initial node, and the operation of obtaining a node type of the initial node is performed. A node type of the initial node d2 is the leaf node type. Whether the to-be-added scene element e1 meets the element addition condition is determined based on the initial node d2. When the to-be-added scene element e1 meets the element addition condition, the to-be-added scene element e1 is added to the initial node d2, to update the initial scene tree structure t2 to an initial scene tree structure t3.

In the foregoing embodiments, node splitting is performed on a node in the initial scene tree structure, and in the node splitting process, the scene element is added to the node in the initial scene tree structure, to obtain the scene tree structure, to subsequently obtain, based on the scene tree structure, the baking element set for lighting baking. Based on the scene tree structure, the scene elements are finely divided into the sub-spaces of the virtual scene. In this way, subsequently, when the baking element set for lighting baking is obtained based on the scene tree structure, a same scene element can be prevented from being repeatedly divided into different baking element sets, thereby reducing a repeated baking task during lighting baking, saving hardware resources, and improving efficiency of lighting baking.

In some embodiments, the element addition condition includes a first element addition condition; and after the obtaining a node type of the initial node, the method further includes: obtaining, when the node type is the leaf node type, the node space of the target node, and an element type and an element space of the to-be-added scene element; and determining, when the element type is an object type and the node space meets a first space division condition, that the to-be-added scene element does not meet the first element addition condition. Based on the element type of the to-be-added scene element, it is determined, in different manners, that the to-be-added scene element does not meet the element addition condition, so that element addition of a scene object, a light mapping task, and a light probe task can be targetedly performed, thereby improving accuracy of scene division.

The node space of the target node is a space corresponding to the target node in the virtual scene. The element space of the to-be-added scene element is a space occupied by the to-be-added scene element in the virtual scene. The element type of the to-be-added scene element may be an object type or a light task type. When the element type of the to-be-added scene element is the object type, it indicates that the to-be-added scene element is a scene object.

In some embodiments, after the obtaining the node space of the target node, and an element type and an element space of the to-be-added scene element, the method further includes: obtaining a preset space size interval; and determining, when a size of the node space does not fall within the preset space size interval, that the node space meets the first space division condition.

Specifically, that the node space meets the first space division condition may be that the size of the node space does not fall within the preset space size interval. The size of the node space that does not fall within the preset space size interval is larger than a size of a node space that falls within the preset space size interval. For example, the preset space size interval is [0, a minimum space size of a sub-node]. When the size of the node space is larger than the minimum space size of the sub-node, the node space meets the first space division condition. The minimum space size of the sub-node may be set according to an actual requirement.

For the initial node, when a node type of the initial node is the leaf node type, the element type of the to-be-added scene element is obtained; and if the element type of the to-be-added scene element is the object type and a size of a node space of the initial node does not fall within the preset space size interval, it is determined that the to-be-added scene element does not meet the first element addition condition.

In some embodiments, the element addition condition includes a second element addition condition; and after the obtaining a node type of the initial node, the method further includes: obtaining, when the node type is the leaf node type, the node space of the target node, and an element type and an element space of the to-be-added scene element; and determining, when the element type is a light task type and the element space and the node space meet a second space division condition, that the to-be-added scene element does not meet the second element addition condition. Based on the element type of the to-be-added scene element, it is determined, in different manners, that the to-be-added scene element does not meet the element addition condition, so that element addition of a scene object, a light mapping task, and a light probe task can be targetedly performed, thereby improving accuracy of scene division.

When the element type of the to-be-added scene element is the light task type, it indicates that the to-be-added scene element is a light mapping task or a light probe task.

In some embodiments, after the obtaining the node space of the target node, and an element type and an element space of the to-be-added scene element, the method further includes: obtaining a third preset percentage; and determining, when a proportion of the node space occupied by the element space does not reach the third preset percentage, that the element space and the node space meet the second space division condition.

That the proportion of the node space occupied by the element space does not reach the third preset percentage may indicate that the element space occupies a smaller space in the node space. The third preset percentage may be set according to an actual requirement. For example, the third preset percentage may be 80%.

For the initial node, when a node type of the initial node is the leaf node type, the element type of the to-be-added scene element is obtained; and if the element type of the to-be-added scene element is the light task type and a proportion of the node space occupied by the element space of the to-be-added scene element does not reach the third preset percentage, it is determined that the to-be-added scene element does not meet the second element addition condition.

When the to-be-added scene element does not meet the first element addition condition or does not meet the second element addition condition, node splitting is performed on the initial node.

In the foregoing embodiments, based on the element type of the to-be-added scene element, it is determined, in different manners, that the to-be-added scene element does not meet the element addition condition, so that element addition of a scene object, a light mapping task, and a light probe task can be targetedly performed, thereby improving accuracy of scene division.

In some embodiments, the element addition condition includes a first element addition condition; and after the obtaining a node type of the initial node, the method further includes: obtaining, when the node type is the leaf node type, the node space of the target node, and an element type and an element space of the to-be-added scene element; and determining, when the element type is an object type and the node space does not meet a first space division condition, that the to-be-added scene element meets the first element addition condition. Based on the element type of the to-be-added scene element, it is determined, in different manners, that the to-be-added scene element meets the element addition condition, so that element addition of a scene object, a light mapping task, and a light probe task can be targetedly performed, thereby improving accuracy of scene division.

In some embodiments, the element addition condition includes a second element addition condition; and after the obtaining a node type of the initial node, the method further includes: obtaining, when the node type is the leaf node type, the node space of the target node, and an element type and an element space of the to-be-added scene element; and determining, when the element type is a light task type and the element space and the node space do not meet a second space division condition, that the to-be-added scene element meets the second element addition condition. Based on the element type of the to-be-added scene element, it is determined, in different manners, that the to-be-added scene element meets the element addition condition, so that element addition of a scene object, a light mapping task, and a light probe task can be targetedly performed, thereby improving accuracy of scene division.

That the node space does not meet the first space division condition may be that a size of the node space falls within a preset space size interval. The size of the node space that falls within the preset space size interval is smaller than a size of a node space that does not fall within the preset space size interval. For example, the preset space size interval is [0, a minimum space size of a sub-node]. When the size of the node space is smaller than or equal to the minimum space size of the sub-node, the node space does not meet the first space division condition.

That the element space and the node space do not meet the second space division condition may be that a proportion of the node space occupied by the element space reaches a third preset percentage. That the proportion of the node space occupied by the element space reaches the third preset percentage may indicate that the element space occupies a larger space in the node space. The third preset percentage may be set according to an actual requirement. For example, the third preset percentage may be 80%.

When the element type is the light task type, the to-be-added scene element is affected by a lighting rebound of surrounding elements. If the proportion of the node space occupied by the element space reaches the third preset percentage, it indicates that other elements other than the to-be-added scene element in the node space each cause lighting rebound impact on the to-be-added scene element. In this case, node splitting may not be performed on the initial node, and the to-be-added scene element is directly added to the initial node, to keep the lighting rebound impact caused by the other elements on the to-be-added scene element, so that lighting baking of the to-be-added scene element is more accurate.

For the initial node, when a node type of the initial node is the leaf node type, the element type of the to-be-added scene element is obtained; if the element type of the to-be-added scene element is the object type and a size of a node space of the initial node falls within the preset space size interval, it is determined that the to-be-added scene element meets the first element addition condition; and if the element type of the to-be-added scene element is the light task type and a proportion of the node space occupied by the element space of the to-be-added scene element reaches the third preset percentage, it is determined that the to-be-added scene element meets the second element addition condition.

When the to-be-added scene element meets the first element addition condition or meets the second element addition condition, the to-be-added scene element is added to the initial node.

In the foregoing embodiments, based on the element type of the to-be-added scene element, it is determined, in different manners, that the to-be-added scene element meets the element addition condition, so that element addition of a scene object, a light mapping task, and a light probe task can be targetedly performed, thereby improving accuracy of scene division.

In some embodiments, after the obtaining a node type of the initial node, the method further includes: obtaining, when the node type is not the leaf node type, a target sub-node corresponding to the to-be-added scene element in sub-nodes of the target node; and using, when a quantity of target sub-nodes does not meet an intersection condition, the target sub-node as an initial node obtained through traversing, and performing the operation of obtaining a node type of the initial node. A node to which a to-be-added scene element is added may be determined layer by layer in the initial scene tree structure, so that the scene elements are finely divided into the sub-spaces of the virtual scene. In this way, subsequently, when the baking element set for lighting baking is obtained based on the scene tree structure, a same scene element can be prevented from being repeatedly divided into different baking element sets, thereby reducing a repeated baking task during lighting baking, saving hardware resources, and improving efficiency of lighting baking and stability of lighting baking.

When the initial node has sub-nodes, the node type of the initial node is not the leaf node type.

In a process of adding a 1^{st} to-be-added scene element to the initial scene tree structure, the initial scene tree structure may be updated, for example, a root node is split into sub-nodes. Therefore, when a 2^{nd} to-be-added scene element is added to the initial scene tree structure, the initial node obtained for the first time is the root node, and a root node included in the current initial scene tree structure may have sub-nodes. Therefore, the node type of the initial node may not be the leaf node type.

The target sub-node is a sub-node whose node space intersects with the element space of the to-be-added scene element. That the target sub-node meets the intersection condition indicates that node spaces respectively corresponding to at least two target sub-nodes intersect with the element space of the to-be-added scene element. Therefore, that the quantity of the target sub-nodes meets the intersection condition may be that the quantity of the target sub-nodes is greater than 1; otherwise, that the quantity of the target sub-nodes does not meet the intersection condition may be that the quantity of the target sub-nodes is equal to 1.

When the initial node has the sub-nodes, it is determined that the node type of the target node is not the leaf node type. The computer device obtains node spaces of the sub-nodes of the target node; obtains the element space of the to-be-added scene element; and uses, for the node space of each of the sub-nodes, the sub-node as the target sub-node when the node space of the sub-node intersects with the element space of the to-be-added scene element. The computer device counts the quantity of target sub-nodes; and determines, when the quantity of target sub-nodes is equal to 1, that the quantity of target sub-nodes does not meet the intersection condition, uses the target sub-node as an initial node, that is, updates the initial node, and performs the operation of obtaining a node type of the initial node. After the operation of obtaining a node type of the initial node is performed, the node type of the initial node may be the leaf node type or may not be the leaf node type.

For example, when a to-be-added scene element e2 is obtained by traversing the scene elements, the initial scene tree structure is shown in FIG. 10. A root node d1 of the initial scene tree structure is used as an initial node, and the initial node d1 has sub-nodes. Therefore, a node type of the initial node d1 is not the leaf node type. The sub-nodes of the initial node d1: a sub-node d2, a sub-node d3, a sub-node d4, and a sub-node d4 are obtained. For each of the sub-nodes of the initial node d1, it is determined whether a node space of the sub-node intersects with an element space of the to-be-added scene element e2. If the node space of the sub-node intersects with the element space of the to-be-added scene element e2, the sub-node is used as a target sub-node. In this example, the target sub-node includes the sub-node d2. The computer device counts a quantity of target sub-nodes as 1, determines that the quantity of target sub-nodes does not meet the intersection condition, uses the sub-node d2 as an initial node, and continues to obtain a node type of the initial node d2. In this example, the node type of the initial node d2 is the leaf node type, and the computer device determines whether the to-be-added scene element e2 meets the element addition condition.

When the to-be-added scene element e2 meets the element addition condition, the to-be-added scene element e2 is added to the initial node d2, and the operation of traversing the scene elements to obtain a to-be-added scene element is performed.

When the to-be-added scene element e2 does not meet the element addition condition, node splitting is performed on the initial node d2, a sub-node of the to-be-added scene element is obtained in sub-nodes obtained through splitting, and the obtained sub-node is used as an initial node. In this way, an initial node to which the to-be-added scene element e2 is added may be obtained through layer-by-layer node splitting, and then the operation of traversing the scene elements to obtain a to-be-added scene element is performed.

After the to-be-added scene element e2 is added to the initial node, a to-be-added scene element e3 is obtained through traversing, and the to-be-added scene element e3 is processed based on the foregoing process, and the to-be-added scene element e3 is added to an initial node.

In the foregoing embodiments, when the node type is not the leaf node type, and the quantity of the target sub-nodes of the to-be-added scene element in the sub-nodes of the initial node does not meet the intersection condition, the target sub-node is used as the initial node, and the operation of obtaining a node type of the initial node is performed. A node to which a to-be-added scene element is added may be determined layer by layer in the initial scene tree structure, so that the scene elements are finely divided into the sub-spaces of the virtual scene. In this way, subsequently, when the baking element set for lighting baking is obtained based on the scene tree structure, a same scene element can be prevented from being repeatedly divided into different baking element sets, thereby reducing a repeated baking task during lighting baking, saving hardware resources, and improving efficiency of lighting baking and stability of lighting baking.

In some embodiments, after the obtaining, when the node type is not the leaf node type, a target sub-node corresponding to the to-be-added scene element in sub-nodes of the target node, the method further includes: adding, when the quantity of target sub-nodes meets the intersection condition, the to-be-added scene element to the initial node, to update the initial scene tree structure, and performing the operation of traversing the scene elements to obtain a to-be-added scene element. In this way, the to-be-added scene element is prevented from being repeatedly added to different sub-nodes, thereby reducing a repeated baking task during lighting baking, saving hardware resources, and improving efficiency of lighting baking.

That the quantity of target sub-nodes meets the intersection condition means that the quantity of target sub-nodes is greater than 1.

In some embodiments, when the initial node has sub-nodes, it is determined that the node type of the target node is not the leaf node type. The computer device obtains node spaces of the sub-nodes of the target node; obtains the element space of the to-be-added scene element; and uses, for the node space of each of the sub-nodes, the sub-node as the target sub-node when the node space of the sub-node intersects with the element space of the to-be-added scene element. The computer device counts the quantity of target sub-nodes; and determines, when the quantity of target sub-nodes is greater than 1, that the quantity of target sub-nodes meets the intersection condition, adds the to-be-added scene element to the initial node, and performs the operation of traversing the scene elements to obtain a to-be-added scene element, to perform the foregoing process of a next to-be-added scene element, and add the next to-be-added scene element to a node of the initial scene tree structure.

When a quantity of sub-nodes whose node spaces intersect with the element space of the to-be-added scene element in the sub-nodes of the initial node is greater than 1, if the to-be-added scene element is added to a sub-node of the initial node, the to-be-added scene element is repeatedly added to the sub-node, and a repeated scene element exists in the baking element set, causing a repeated baking task during lighting baking.

For example, when a to-be-added scene element e2 is obtained by traversing the scene elements, the initial scene tree structure is like t3 shown in FIG. 10. A root node d1 of the initial scene tree structure is used as an initial node, and the initial node d1 has sub-nodes. Therefore, a node type of the initial node d1 is not the leaf node type. The sub-nodes of the initial node d1: a sub-node d2, a sub-node d3, a sub-node d4, and a sub-node d4 are obtained. For each of the sub-nodes of the initial node d1, it is determined whether a node space of the sub-node intersects with an element space of the to-be-added scene element e2. If the node space of the sub-node intersects with the element space of the to-be-added scene element e2, the sub-node is used as a target sub-node. In this example, the target sub-node includes the sub-node d2 and the sub-node d3. The computer device counts a quantity of target sub-nodes as 2, determines that the quantity of target sub-nodes meets the intersection condition, adds a to-be-added scene element e2 to an initial node d2, and perform the operation of traversing the scene elements to obtain a to-be-added scene element.

After the to-be-added scene element e2 is added to the initial node, a to-be-added scene element e3 is obtained through traversing, and the to-be-added scene element e3 is processed based on the foregoing process, and the to-be-added scene element e3 is added to an initial node.

In the foregoing embodiments, when the quantity of target sub-nodes meets the intersection condition, the to-be-added scene element is added to the initial node. In this way, the to-be-added scene element is prevented from being repeatedly added to different sub-nodes, thereby reducing a repeated baking task during lighting baking, saving hardware resources, and improving efficiency of lighting baking.

In some embodiments, after the obtaining lighting information of the baking element set, the method further includes: obtaining lighting information of all scene elements in preset sub-scenes of the virtual scene based on the lighting information of the baking element set, and storing the lighting information of all the scene elements in the preset sub-scenes. In this manner, the lighting information may be stored while lighting baking is performed, so that parallel processing of the lighting information is implemented, thereby improving efficiency of storing the lighting information of the virtual scene. In addition, the lighting information stored in the local memory is stored based on the preset sub-scenes in the virtual scene, and when lighting information of a preset sub-scene needs to be used, the lighting information of the preset sub-scene may be quickly obtained from the local memory.

A plurality of preset sub-scenes may be provided, each of the preset sub-scenes is a partial scene in the virtual scene, and the virtual scene includes the plurality of preset sub-scenes. During actual application, a game includes a plurality of levels, and a virtual scene of the game includes preset sub-scenes respectively corresponding to the plurality of levels. Alternatively, the game includes a plurality of sub-maps, and the virtual scene of the game includes preset sub-scenes respectively corresponding to the plurality of sub-maps.

The lighting information of all the scene elements in the preset sub-scenes includes lighting information corresponding to light mapping tasks in the preset sub-scenes, and lighting information corresponding to light probe tasks in the preset sub-scenes. Lighting information corresponding to a light mapping task in the preset sub-scene is lighting information of a surface of a scene object associated with the light mapping task in the preset sub-scene. Lighting information corresponding to a light probe task in the preset sub-scene is lighting information of a spatial location of the light probe task in the preset sub-scene.

In some embodiments, the computer device sequentially performs lighting baking on baking element sets, to sequentially obtain lighting information of each of the baking element sets. Each time lighting information of one baking element set is obtained, lighting information belonging to each of preset sub-scenes is obtained in the lighting information of the baking element set. Each time complete lighting information of one preset sub-scene is obtained, the complete lighting information of the preset sub-scene is stored in the local memory. In this way, subsequently, when lighting information of a scene element needs to be used, the lighting information can be obtained from the memory. Each time lighting information of one preset sub-scene is stored, a memory resource required for storing the lighting information of the preset sub-scene may be released in time. In this way, when lighting information of other preset sub-scenes is stored, there is a sufficient available memory space, thereby avoiding an insufficient memory when the lighting information of the entire virtual scene is stored.

For example, after lighting information of a baking element set B1 is obtained, a first part of lighting information of a preset sub-scene L1 and a first part of lighting information of a preset sub-scene L2 may be obtained in the lighting information of the baking element set B1. After lighting information of a baking element set B2 is obtained, a second part of lighting information of the preset sub-scene L1 and a first part of lighting information of the preset sub-scene L3 may be obtained in the lighting information of the baking element set B2. Complete lighting information of the preset sub-scene L1 is obtained based on the first part of lighting information of the preset sub-scene L1 and the second part of lighting information of the preset sub-scene L1. The complete lighting information of the preset sub-scene L1 is obtained in the lighting information of the baking element set B1 and the lighting information of the baking element set B2. The computer device stores the complete lighting information of the preset sub-scene L1.

In the foregoing embodiments, the lighting information may be stored while lighting baking is performed, so that parallel processing of the lighting information is implemented, thereby improving efficiency of storing the lighting information of the virtual scene. In addition, the lighting information stored in the local memory is stored based on the preset sub-scenes in the virtual scene, and when lighting information of a preset sub-scene needs to be used, the lighting information of the preset sub-scene may be quickly obtained from the local memory.

In some embodiments, at least two preset sub-scenes are provided; and the obtaining lighting information of all scene elements in preset sub-scenes of the virtual scene based on the lighting information of the baking element set, and storing the lighting information of all the scene elements in the preset sub-scenes includes: obtaining sub-scene identifiers of scene elements in the baking element set; obtaining, in lighting information of the scene elements in the baking element set, lighting information of the scene elements in the preset sub-scenes based on the sub-scene identifiers; and storing, when lighting information of all scene elements in any preset sub-scene is obtained, the lighting information of all the scene elements in the any preset sub-scene. When lighting baking is performed, the lighting information of the preset sub-scene is stored. In this way, compared with that the lighting information of the entire virtual scene is stored after the lighting information of the entire virtual scene is obtained, the insufficient memory when the lighting information of the entire virtual scene is stored is avoided, and the problem that lighting baking performed on the virtual scene is limited by hardware resources is resolved.

A sub-scene identifier is configured for reflecting a preset sub-scene to which a scene element belongs. For example, when a scene element e1 belongs to a preset sub-scene level1, a sub-scene identifier of the scene element e1 may be level1. When a scene element e2 belongs to a preset sub-scene level2, a sub-scene identifier of the scene element e2 may be level2. A level may indicate a level in the game, and the preset sub-scene level1 may be a sub-scene of a 1^{st} level in a virtual scene of the game.

The computer device may add the sub-scene identifiers to the scene elements in advance, and generate lighting information sets of the preset sub-scenes. The lighting information sets of the preset sub-scene include the sub-scene identifiers of the scene elements in the preset sub-scenes. The sub-scene identifiers of the scene elements in the lighting information set of the preset sub-scene are specifically a sub-scene identifier of a light mapping task and a sub-scene identifier of a light probe task in the preset sub-scene.

The lighting information of the baking element set includes lighting information of a light mapping task and lighting information of a light probe task. The computer device obtains a sub-scene identifier of the light mapping task and a sub-scene identifier of the light probe task; divides the lighting information of the light mapping task and the lighting information of the light probe task into the lighting information sets of the preset sub-scenes based on the sub-scene identifiers in the lighting information sets of the preset sub-scenes; and stores, when a lighting information set of a preset sub-scene includes lighting information of all light mapping tasks and light probe tasks in the preset sub-scene, the lighting information set of the preset sub-scene to the memory.

In some embodiments, after the lighting information of all the scene elements in the any preset sub-scene is stored, a memory resource for storing the lighting information of the preset sub-scene is released. That the memory resource for storing the lighting information of the preset sub-scene is released may be that the computer device transmits the lighting information of the preset sub-scene to a storage server or an external storage apparatus, so that the computer device has sufficient memory resources for storing lighting information of other preset sub-scenes. In this way, the insufficient memory when the lighting information is stored is avoided, and the problem that lighting baking performed on the virtual scene is limited by hardware resources is resolved.

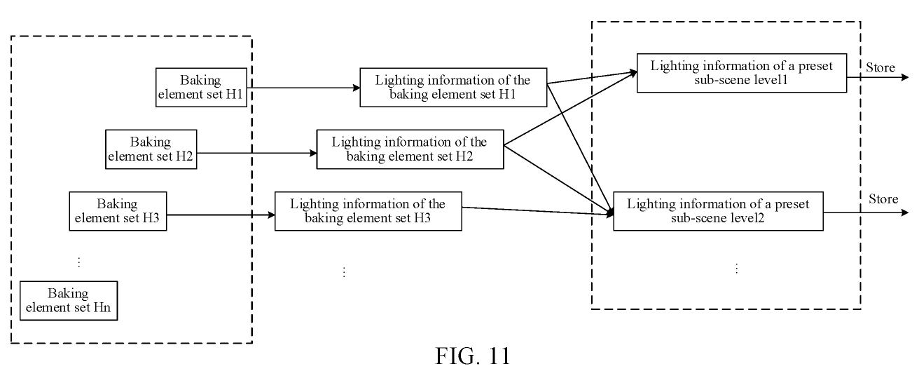

For example, in the related technology, generally, after all lighting baking tasks of the virtual scene are executed, all lighting information of the virtual scene is exported to the local memory. However, in the embodiments of this application, as shown in FIG. 11, a plurality of baking element sets: a baking element set H1, a baking element set H2, …, and a baking element set Hn may be determined based on the scene tree structure. Lighting baking is sequentially performed on the plurality of baking element sets. Each time lighting baking on one baking element set is completed, lighting information of the baking element set is divided into the lighting information sets of the preset sub-scenes. In the process of sequentially performing lighting baking on the baking element sets, complete lighting information of each of the preset sub-scenes may be gradually obtained. Each time complete lighting information of one preset sub-scene is obtained, the complete lighting information of the preset sub-scene is first stored, and a memory resource for storing the complete lighting information of the preset sub-scene is released. For example, when all lighting information of the preset sub-scene level1 is obtained, all the lighting information of the preset sub-scene level1 is stored to the local memory, and a memory resource for storing the lighting information of the preset sub-scene level1 is released. When all lighting information of the preset sub-scene level2 is obtained, all the lighting information of the preset sub-scene level2 is stored to the local memory.

In the foregoing embodiments, when lighting baking is performed, the lighting information of the preset sub-scene is stored. In this way, compared with that the lighting information of the entire virtual scene is stored after the lighting information of the entire virtual scene is obtained, the insufficient memory when the lighting information of the entire virtual scene is stored is avoided, and the problem that lighting baking performed on the virtual scene is limited by hardware resources is resolved.

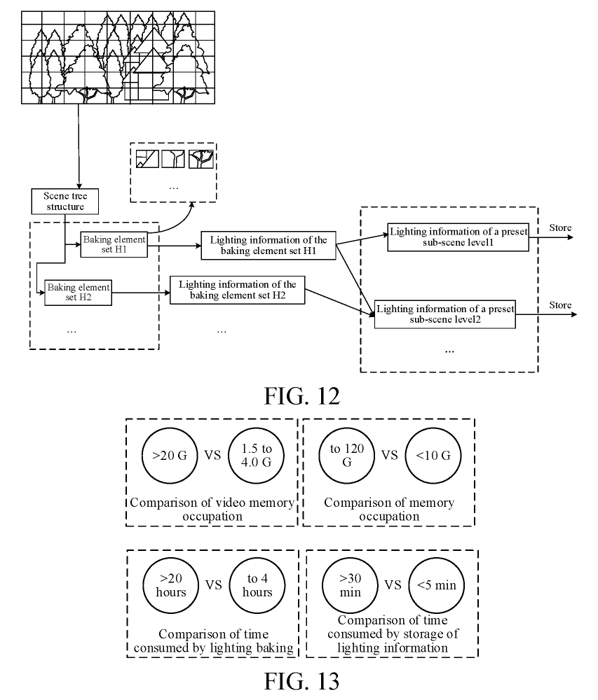

In some embodiments, as shown in FIG. 12, the lighting baking method for a virtual scene may be applied to a scene in which lighting baking is performed on a virtual scene of an open-world game.

Scene elements in the virtual scene of the open-world game, including a scene object, a lighting baking task, and a light probe task in the virtual scene, are obtained. Scene division is performed on the virtual scene of the open-world game based on the scene elements, to obtain a scene tree structure of a quadtree structure. The scene tree structure includes a plurality of spatial nodes, and some or all of the plurality of spatial nodes include at least one scene element. For the scene tree structure, reference is made to FIG. 4.

The spatial nodes in the scene tree structure are traversed to obtain a target node d2. When it is determined, based on a quantity of elements of the target node d2 and a quantity of elements of descendant nodes of the target node d2, that the target node d2 meets a baking condition, a baking element set H1 is determined based on scene elements of the target node d2, scene elements of an ancestor node of the target node d2, and scene elements of the descendant nodes. In this example, the ancestor node of the target node d2 is a node d1, and the descendant nodes of the target node d2 are a node d6, a node d7, a node d8, and a node d9. The baking element set H1 includes: a scene element e1, a scene element e2, a scene element e3, and a scene element e4.

In a same manner, it may be determined that a baking element set H2 of a target node d3 includes a scene element e5, a scene element e6, a scene element e7, and a scene element e8.

After lighting baking is sequentially performed on the baking element set H1 and the baking element set H2 to obtain lighting information of the baking element set H1, lighting information of scene elements in a preset sub-scene level1 and lighting information of scene elements in a preset sub-scene level2 are obtained in the lighting information of the baking element set H1.

In this example, the scene elements in the preset sub-scene level1 include the scene element e1 and the scene element e2; and the scene elements in the preset sub-scene level2 include the scene element e3, the scene element e4, the scene element e5, the scene element e6, the scene element e7, and the scene element e8.

All lighting information of the preset sub-scene level1 may be obtained based on the lighting information of the baking element set H1, the lighting information of the preset sub-scene level1 is stored, and a memory resource for storing the lighting information of the preset sub-scene level1 is released.

Lighting information of the scene element e3 and the scene element e4 in the preset sub-scene level2 may be obtained based on the lighting information of the baking element set H1. After lighting baking on the baking element set H2 is completed, lighting information of the baking element set H2 is obtained, so that lighting information of the scene element e5, the scene element e6, the scene element e7, and the scene element e8 in the preset sub-scene level2 may be obtained. Further, all lighting information of the preset sub-scene level2 is obtained, and the lighting information of the preset sub-scene level2 is stored.

During actual application, 520 thousand light mapping tasks and 2.7 million scene objects are designed in a virtual scene of an open-world game. Comparison between an effect of directly performing lighting baking on the entire virtual scene and an effect of performing lighting baking by using the method provided in this embodiment of this application is shown in FIG. 13. In each dashed box in FIG. 13, a left side is a case in which lighting baking is performed on all scene elements in the virtual scene, and a right side is a case in which lighting baking is performed by using the method provided in this embodiment of this application. Apparently, by using the method provided in this embodiment of this application, video memory occupation and memory occupation can be greatly reduced. Occupation on a video memory and a memory in the method provided in this embodiment of this application is smaller, so that the method provided in this embodiment of this application may be applicable to a low-end video card (a video card with a low processing capability). In addition, by using the method provided in this embodiment of this application, time consumed by lighting baking and storage of lighting information can also be greatly reduced, thereby improving efficiency of lighting baking.

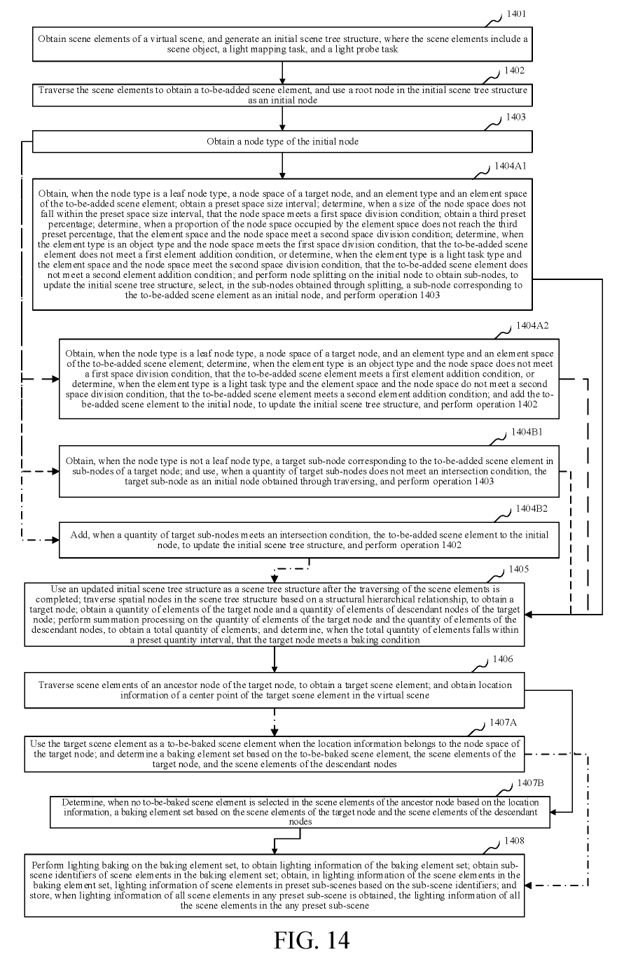

In some embodiments, as shown in FIG. 14, a lighting baking method for a virtual scene includes the following operations:

Operation 1401: Obtain scene elements of a virtual scene, and generate an initial scene tree structure.

Operation 1402: Traverse the scene elements to obtain a to-be-added scene element, and use a root node in the initial scene tree structure as an initial node.

Operation 1403: Obtain a node type of the initial node.

Operation 1404A1: Obtain, when the node type is a leaf node type, a node space of a target node, and an element type and an element space of the to-be-added scene element; obtain a preset space size interval; determine, when a size of the node space does not fall within the preset space size interval, that the node space meets a first space division condition; obtain a third preset percentage; determine, when a proportion of the node space occupied by the element space does not reach the third preset percentage, that the element space and the node space meet a second space division condition; determine, when the element type is an object type and the node space meets the first space division condition, that the to-be-added scene element does not meet a first element addition condition, or determine, when the element type is a light task type and the element space and the node space meet the second space division condition, that the to-be-added scene element does not meet a second element addition condition; and perform node splitting on the initial node to obtain sub-nodes, to update the initial scene tree structure, select, in the sub-nodes obtained through splitting, a sub-node corresponding to the to-be-added scene element as an initial node, and perform operation 1403.

Operation 1404A2: Obtain, when the node type is a leaf node type, a node space of a target node, and an element type and an element space of the to-be-added scene element; determine, when the element type is an object type and the node space does not meet a first space division condition, that the to-be-added scene element meets a first element addition condition, or determine, when the element type is a light task type and the element space and the node space do not meet a second space division condition, that the to-be-added scene element meets a second element addition condition; and add the to-be-added scene element to the initial node, to update the initial scene tree structure, and perform operation 1402.

Operation 1404B1: Obtain, when the node type is not a leaf node type, a target sub-node corresponding to the to-be-added scene element in sub-nodes of a target node; and use, when a quantity of target sub-nodes does not meet an intersection condition, the target sub-node as an initial node obtained through traversing, and perform operation 1403.

Operation 1404B2: Add, when a quantity of target sub-nodes meets an intersection condition, the to-be-added scene element to the initial node, to update the initial scene tree structure, and perform operation 1402.

Operation 1405: Use an updated initial scene tree structure as a scene tree structure after the traversing of the scene elements is completed; traverse spatial nodes in the scene tree structure based on a structural hierarchical relationship, to obtain a target node; obtain a quantity of elements of the target node and a quantity of elements of descendant nodes of the target node; perform summation processing on the quantity of elements of the target node and the quantity of elements of the descendant nodes, to obtain a total quantity of elements; and determine, when the total quantity of elements falls within a preset quantity interval, that the target node meets a baking condition.

Operation 1406: Traverse scene elements of an ancestor node of the target node, to obtain a target scene element; and obtain location information of a center point of the target scene element in the virtual scene.

Operation 1407A: Use the target scene element as a to-be-baked scene element when the location information belongs to the node space of the target node; and determine a baking element set based on the to-be-baked scene element, the scene elements of the target node, and the scene elements of the descendant nodes.

Operation 1407B: Determine, when no to-be-baked scene element is selected in the scene elements of the ancestor node based on the location information, a baking element set based on the scene elements of the target node and the scene elements of the descendant nodes.

Operation 1408: Perform lighting baking on the baking element set, to obtain lighting information of the baking element set; obtain sub-scene identifiers of scene elements in the baking element set; obtain, in lighting information of the scene elements in the baking element set, lighting information of scene elements in preset sub-scenes based on the sub-scene identifiers; and store, when lighting information of all scene elements in any preset sub-scene is obtained, the lighting information of all the scene elements in the any preset sub-scene.

In the foregoing lighting baking method for a virtual scene, scene division is performed on scene elements in a virtual scene, to obtain a scene tree structure; a target node is obtained through traversing in the scene tree structure; when a quantity of elements of the target node and a quantity of elements of descendant nodes of the target node meet a baking condition, a baking element set is determined based on scene elements included in each of the target node and an ancestor node and the descendant nodes of the target node, so that a quantity of scene elements in the baking element set is smaller; and lighting baking is performed on the baking element set, so that a quantity of scene elements participating in lighting baking once is smaller. This can reduce a video memory occupation rate in a lighting baking process, and can improve stability of lighting baking.

Although steps in the flowcharts involved in the foregoing embodiments are displayed sequentially according to instructions of arrows, these steps are not necessarily performed sequentially according to a sequence instructed by the arrows. Unless otherwise explicitly specified in this specification, execution of the steps is not strictly limited, and the steps may be performed in other sequences. In addition, at least some steps in the flowcharts involved in the foregoing embodiments may include a plurality of steps or a plurality of stages, and these steps or stages are not necessarily performed at a same time instant, but may be performed at different time instants. The steps or stages are not necessarily performed in sequence, but may be performed by turn or alternately with other steps or at least part of steps or stages in other steps.

Based on the same inventive concept, an embodiment of this application further provides a lighting baking apparatus for a virtual scene configured to implement the foregoing lighting baking method for a virtual scene. The solution to the problem provided by the apparatus is similar to the solution described in the foregoing method. Therefore, for specific limitations in one or more embodiments of the lighting baking apparatus for a virtual scene provided below, reference may be made to the limitations on the foregoing lighting baking method for a virtual scene. Details are not repeated herein again.

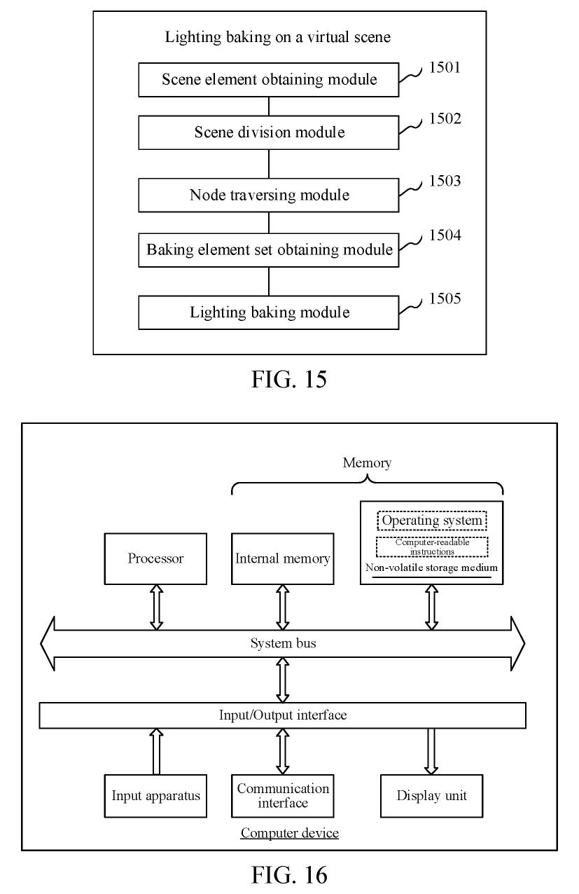

In some embodiments, as shown in FIG. 15, a lighting baking apparatus for a virtual scene is provided, including: a scene element obtaining module 1501, a scene division module 1502, a node traversing module 1503, a baking element set obtaining module 1504, and a lighting baking module 1505.

The scene element obtaining module 1501 is configured to obtain scene elements in a virtual scene.

The scene division module 1502 is configured to perform scene division on the virtual scene based on the scene elements, to obtain a scene tree structure.

The node traversing module 1503 is configured to traverse spatial nodes in the scene tree structure based on a structural hierarchical relationship, to obtain a target node.

The baking element set obtaining module 1504 is configured to when it is determined, based on a quantity of elements of the target node and a quantity of elements of descendant nodes of the target node, that the target node meets a baking condition, determine a baking element set based on scene elements of the target node, scene elements of an ancestor node of the target node, and scene elements of the descendant nodes.

The lighting baking module 1505 is configured to perform lighting baking on the baking element set, to obtain lighting information of the baking element set.

In the foregoing lighting baking apparatus for a virtual scene, scene division is performed on scene elements in a virtual scene, to obtain a scene tree structure; a target node is obtained through traversing in the scene tree structure; when a quantity of elements of the target node and a quantity of elements of descendant nodes of the target node meet a baking condition, a baking element set is determined based on scene elements included in each of the target node and an ancestor node and the descendant nodes of the target node, so that a quantity of scene elements in the baking element set is smaller; and lighting baking is performed on the baking element set, so that a quantity of scene elements participating in lighting baking once is smaller. This can reduce a video memory occupation rate in a lighting baking process, and can improve stability of lighting baking.

In some embodiments, the lighting baking apparatus for a virtual scene further includes: a baking condition determining module, configured to obtain the quantity of elements of the target node and the quantity of elements of the descendant nodes of the target node; perform summation processing on the quantity of elements of the target node and the quantity of elements of the descendant nodes, to obtain a total quantity of elements; and determine, when the total quantity of elements falls within a preset quantity interval, that the target node meets the baking condition.

In some embodiments, the baking element set obtaining module 1504 is further configured to obtain location information corresponding to the scene elements of the ancestor node of the target node; select, based on the location information, a to-be-baked scene element in the scene elements of the ancestor node; and determine the baking element set based on the to-be-baked scene element, the scene elements of the target node, and the scene elements of the descendant nodes.

In some embodiments, the baking element set obtaining module 1504 is further configured to traverse the scene elements of the ancestor node of the target node to obtain a target scene element; obtain location information of a center point of the target scene element in the virtual scene; and use the target scene element as the to-be-baked scene element when the location information belongs to a node space of the target node.

In some embodiments, the baking element set obtaining module 1504 is further configured to obtain the location information corresponding to the scene elements of the ancestor node of the target node; and

determine, when no to-be-baked scene element is selected in the scene elements of the ancestor node based on the location information, the baking element set based on the scene elements of the target node and the scene elements of the descendant nodes.

In some embodiments, the scene division module 1502 is further configured to generate an initial scene tree structure; traverse the scene elements to obtain a to-be-added scene element, and use a root node in the initial scene tree structure as an initial node; obtain a node type of the initial node; when the node type is a leaf node type, when the to-be-added scene element does not meet an element addition condition, perform node splitting on the initial node to obtain sub-nodes, to update the initial scene tree structure, select, in the sub-nodes obtained through splitting, a sub-node corresponding to the to-be-added scene element as an initial node, and perform the operation of obtaining a node type of the initial node; add, when the to-be-added scene element meets the element addition condition, the to-be-added scene element to the initial node, to update the initial scene tree structure, and perform the operation of traversing the scene elements to obtain a to-be-added scene element; and use an updated initial scene tree structure as the scene tree structure after the traversing of the scene elements is completed.

In some embodiments, the element addition condition includes a first element addition condition; and the scene division module 1502 is further configured to obtain, when the node type is the leaf node type, the node space of the target node, and an element type and an element space of the to-be-added scene element; and determine, when the element type is an object type and the node space meets a first space division condition, that the to-be-added scene element does not meet the first element addition condition.

In some embodiments, the element addition condition includes a second element addition condition; and the scene division module 1502 is further configured to obtain, when the node type is the leaf node type, the node space of the target node, and an element type and an element space of the to-be-added scene element; and determine, when the element type is a light task type and the element space and the node space meet a second space division condition, that the to-be-added scene element does not meet the second element addition condition.

In some embodiments, the element addition condition includes a first element addition condition; and the scene division module 1502 is further configured to obtain, when the node type is the leaf node type, the node space of the target node, and an element type and an element space of the to-be-added scene element; and determine, when the element type is an object type and the node space does not meet a first space division condition, that the to-be-added scene element meets the first element addition condition.

In some embodiments, the element addition condition includes a second element addition condition; and the scene division module 1502 is further configured to obtain, when the node type is the leaf node type, the node space of the target node, and an element type and an element space of the to-be-added scene element; and determine, when the element type is a light task type and the element space and the node space do not meet a second space division condition, that the to-be-added scene element meets the second element addition condition.

In some embodiments, the scene division module 1502 is further configured to obtain a preset space size interval; and determine, when a size of the node space does not fall within the preset space size interval, that the node space meets the first space division condition.

In some embodiments, the scene division module 1502 is further configured to obtain a third preset percentage; and determine, when a proportion of the node space occupied by the element space does not reach the third preset percentage, that the element space and the node space meet the second space division condition.

In some embodiments, the scene division module 1502 is further configured to obtain, when the node type is not the leaf node type, a target sub-node corresponding to the to-be-added scene element in sub-nodes of the target node; and use, when a quantity of target sub-nodes does not meet an intersection condition, the target sub-node as an initial node obtained through traversing, and perform the operation of obtaining a node type of the initial node.

In some embodiments, the scene division module 1502 is further configured to add, when the quantity of target sub-nodes meets the intersection condition, the to-be-added scene element to the initial node, to update the initial scene tree structure, and perform the operation of traversing the scene elements to obtain a to-be-added scene element.

In some embodiments, the lighting baking apparatus for a virtual scene further includes: a lighting information storage module, configured to obtain lighting information of all scene elements in preset sub-scenes of the virtual scene based on the lighting information of the baking element set, and store the lighting information of all the scene elements in the preset sub-scenes.

In some embodiments, at least two preset sub-scenes are provided; and the lighting information storage module is further configured to obtain sub-scene identifiers of scene elements in the baking element set; obtain, in lighting information of the scene elements in the baking element set, lighting information of the scene elements in the preset sub-scenes based on the sub-scene identifiers; and store, when lighting information of all scene elements in any preset sub-scene is obtained, the lighting information of all the scene elements in the any preset sub-scene.

The modules in the foregoing lighting baking apparatus for a virtual scene may be implemented entirely or partially by software, hardware, or combinations thereof. The foregoing modules may be built in or independent of a processor of a computer device in a hardware form, or may be stored in a memory of the computer device in a software form, so that the processor invokes and performs an operation corresponding to each of the foregoing modules.

In some embodiments, a computer device is provided. The computer device may be a server, or may be a terminal. The computer device is used as the server for description, and a diagram of an internal structure of the computer device may be shown in FIG. 16. The computer device includes a processor, a memory, an input/output (I/O) interface, and a communication interface. The processor, the memory, and the input/output interface are connected via a system bus, and the communication interface is connected to the system bus via the input/output interface. The processor of the computer device is configured to provide computing and control capabilities. The memory of the computer device includes a non-volatile storage medium and an internal memory. The non-volatile storage medium stores an operating system, a computer program, and a database. The internal memory provides an environment for running of the operating system and the computer program in the non-volatile storage medium. The database of the computer device is configured to store data related to the lighting baking method for a virtual scene. The input/output interface of the computer device is configured to exchange information between the processor and an external device. The communication interface of the computer device is configured to communicate with an external terminal through a network connection. The computer program is executed by the processor to implement a lighting baking method for a virtual scene.

A person skilled in the art may understand that, the structure shown in FIG. 16 is only a block diagram of a part of a structure related to a solution of this application and does not limit the computer device to which the solution of this application is applied. Specifically, the computer device may include more or fewer components than those in the drawings, or some components are combined, or a different component deployment is used.

In some embodiments, a computer device is provided, including a memory and a processor. The memory has a computer program stored therein. The processor, when executing the computer program, implements operations of the foregoing lighting baking method for a virtual scene.

In some embodiments, a computer-readable storage medium is provided, having a computer program stored therein. The computer program, when executed by a processor, implements operations of the foregoing lighting baking method for a virtual scene.

In some embodiments, a computer program product is provided, including a computer program. The computer program, when executed by a processor, implements operations of the foregoing lighting baking method for a virtual scene.

User information (including but not limited to user device information, user personal information, and the like) and data (including but not limited to data used for analysis, stored data, displayed data, and the like) involved in this application are information and data authorized by a user or fully authorized by all parties, and collection, use, and processing of relevant data need to comply with relevant regulations.

A person of ordinary skill in the art may understand that some or all procedures in the foregoing method embodiments may be implemented by a computer program instructing related hardware. The computer program may be stored in a non-volatile computer-readable storage medium, and when the computer program is executed, the procedures of the foregoing method embodiments may be performed. Any reference to a memory, a database, or another medium used in the embodiments provided in this application may include at least one of a non-volatile memory and a volatile memory. The non-volatile memory may include a read-only memory (ROM), a magnetic tape, a floppy disk, a flash memory, an optical memory, a high-density embedded non-volatile memory, a resistive memory (ReRAM), a magnetoresistive random access memory (MRAM), a ferroelectric random access memory (FRAM), a phase change memory (PCM), a graphene memory, or the like. The volatile memory may include a random access memory (RAM), an external cache, or the like. For the purpose of description instead of limitation, the RAM is available in a plurality of forms, such as a static random access memory (SRAM) or a dynamic random access memory (DRAM). The database involved in the embodiments provided in this application may include at least one of a relational database and a non-relational database. The non-relational database may include a blockchain-based distributed database, or the like, but is not limited thereto. The processor involved in the embodiments provided in this application may be a general-purpose processor, a central processing unit, a graphics processor, a digital signal processor, a programmable logic device, a quantum computing-based data processing logic device, or the like, but is not limited thereto.

Technical features of the foregoing embodiments may be combined in different manners to form other embodiments. To make description concise, not all possible combinations of the technical features in the foregoing embodiments are described. However, the combinations of these technical features shall be considered as falling within the scope recorded by this specification provided that no conflict exists.

The foregoing embodiments only show several implementations of this application, and descriptions thereof are in detail, but are not to be understood as a limitation to the patent scope of this application. A person of ordinary skill in the art may further make several variations and improvements without departing from the ideas of this application, and such variations and improvements all fall within the protection scope of this application. Therefore, the protection scope of this application shall be subject to the protection scope of the appended claims. In this application, the term “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module can be implemented using one or more processors (or processors and memory). Likewise, a processor (or processors and memory) can be used to implement one or more modules. Moreover, each module can be part of an overall module that includes the functionalities of the module or unit.

What is claimed is:

1. A lighting baking method for a virtual scene performed by a computer device, the method comprising:
obtaining scene elements in a virtual scene;
performing scene division on the virtual scene based on the scene elements, to obtain a scene tree structure;
traversing spatial nodes in the scene tree structure based on a structural hierarchical relationship of the scene tree structure, to obtain a target node;
after determining that the target node meets a predetermined baking condition based on a quantity of elements of the target node and a quantity of elements of descendant nodes of the target node, determining a baking element set based on scene elements of the target node, scene elements of an ancestor node of the target node, and scene elements of the descendant nodes; and
performing lighting baking on the baking element set, to obtain lighting information of the baking element set.

2. The method according to claim 1, wherein the target node meets the predetermined baking condition when a total of the quantity of elements of the target node and the quantity of elements of the descendant nodes of the target node falls within a preset quantity interval.

3. The method according to claim 1, wherein the determining a baking element set based on scene elements of the target node, scene elements of an ancestor node of the target node, and scene elements of the descendant nodes comprises:
obtaining location information corresponding to the scene elements of the ancestor node of the target node;
selecting, based on the location information, a to-be-baked scene element in the scene elements of the ancestor node; and
determining the baking element set based on the to-be-baked scene element, the scene elements of the target node, and the scene elements of the descendant nodes.

4. The method according to claim 1, wherein the determining a baking element set based on scene elements of the target node, scene elements of an ancestor node of the target node, and scene elements of the descendant nodes comprises:
obtaining location information corresponding to the scene elements of the ancestor node of the target node; and
determining, when no to-be-baked scene element is selected in the scene elements of the ancestor node based on the location information, the baking element set based on the scene elements of the target node and the scene elements of the descendant nodes.

5. The method according to claim 1, wherein the performing scene division on the virtual scene based on the scene elements, to obtain a scene tree structure comprises:
generating an initial scene tree structure;
traversing the scene elements to obtain a to-be-added scene element, and using a root node in the initial scene tree structure as an initial node;
obtaining a node type of the initial node;
when the node type is a leaf node type, when the to-be-added scene element does not meet an element addition condition, performing node splitting on the initial node to obtain sub-nodes, to update the initial scene tree structure, selecting, in the sub-nodes obtained through splitting, a sub-node corresponding to the to-be-added scene element as an initial node, and performing the operation of obtaining a node type of the initial node;
adding, when the to-be-added scene element meets the element addition condition, the to-be-added scene element to the initial node, to update the initial scene tree structure, and performing the operation of traversing the scene elements to obtain a to-be-added scene element; and
using an updated initial scene tree structure as the scene tree structure after the traversing of the scene elements is completed.

6. The method according to claim 1, wherein the method further comprises:
obtaining lighting information of scene elements in preset sub-scenes of the virtual scene based on the lighting information of the baking element set; and
storing the lighting information of all the scene elements in the preset sub-scenes.

7. The method according to claim 6, wherein the method further comprises:
obtaining sub-scene identifiers of scene elements in the baking element set;
obtaining, in lighting information of the scene elements in the baking element set, lighting information of the scene elements in the preset sub-scenes based on the sub-scene identifiers; and
storing, when lighting information of all scene elements in any preset sub-scene is obtained, the lighting information of all the scene elements in the any preset sub-scene.

8. A computer device, comprising a memory and one or more processors, the memory having computer-readable instructions stored therein, the computer-readable instructions, when executed by the one or more processors, causing the computer device to perform a lighting baking method for a virtual scene including:
obtaining scene elements in a virtual scene;
performing scene division on the virtual scene based on the scene elements, to obtain a scene tree structure;
traversing spatial nodes in the scene tree structure based on a structural hierarchical relationship of the scene tree structure, to obtain a target node;
after determining that the target node meets a predetermined baking condition based on a quantity of elements of the target node and a quantity of elements of descendant nodes of the target node, determining a baking element set based on scene elements of the target node, scene elements of an ancestor node of the target node, and scene elements of the descendant nodes; and
performing lighting baking on the baking element set, to obtain lighting information of the baking element set.

9. The computer device according to claim 8, wherein the target node meets the predetermined baking condition when a total of the quantity of elements of the target node and the quantity of elements of the descendant nodes of the target node falls within a preset quantity interval.

10. The computer device according to claim 8, wherein the determining a baking element set based on scene elements of the target node, scene elements of an ancestor node of the target node, and scene elements of the descendant nodes comprises:
obtaining location information corresponding to the scene elements of the ancestor node of the target node;
selecting, based on the location information, a to-be-baked scene element in the scene elements of the ancestor node; and
determining the baking element set based on the to-be-baked scene element, the scene elements of the target node, and the scene elements of the descendant nodes.

11. The computer device according to claim 8, wherein the determining a baking element set based on scene elements of the target node, scene elements of an ancestor node of the target node, and scene elements of the descendant nodes comprises:
obtaining location information corresponding to the scene elements of the ancestor node of the target node; and
determining, when no to-be-baked scene element is selected in the scene elements of the ancestor node based on the location information, the baking element set based on the scene elements of the target node and the scene elements of the descendant nodes.

12. The computer device according to claim 8, wherein the performing scene division on the virtual scene based on the scene elements, to obtain a scene tree structure comprises:
generating an initial scene tree structure;
traversing the scene elements to obtain a to-be-added scene element, and using a root node in the initial scene tree structure as an initial node;
obtaining a node type of the initial node;
when the node type is a leaf node type, when the to-be-added scene element does not meet an element addition condition, performing node splitting on the initial node to obtain sub-nodes, to update the initial scene tree structure, selecting, in the sub-nodes obtained through splitting, a sub-node corresponding to the to-be-added scene element as an initial node, and performing the operation of obtaining a node type of the initial node;
adding, when the to-be-added scene element meets the element addition condition, the to-be-added scene element to the initial node, to update the initial scene tree structure, and performing the operation of traversing the scene elements to obtain a to-be-added scene element; and
using an updated initial scene tree structure as the scene tree structure after the traversing of the scene elements is completed.

13. The computer device according to claim 8, wherein the method further comprises:
obtaining lighting information of scene elements in preset sub-scenes of the virtual scene based on the lighting information of the baking element set; and
storing the lighting information of all the scene elements in the preset sub-scenes.

14. The computer device according to claim 13, wherein the method further comprises:
obtaining sub-scene identifiers of scene elements in the baking element set;
obtaining, in lighting information of the scene elements in the baking element set, lighting information of the scene elements in the preset sub-scenes based on the sub-scene identifiers; and
storing, when lighting information of all scene elements in any preset sub-scene is obtained, the lighting information of all the scene elements in the any preset sub-scene.

15. One or more non-transitory readable storage media, having computer-readable instructions stored therein, the computer-readable instructions, when executed by one or more processors of a computer device, causing the computer device to perform a lighting baking method for a virtual scene including:
obtaining scene elements in a virtual scene;
performing scene division on the virtual scene based on the scene elements, to obtain a scene tree structure;
traversing spatial nodes in the scene tree structure based on a structural hierarchical relationship of the scene tree structure, to obtain a target node;
after determining that the target node meets a predetermined baking condition based on a quantity of elements of the target node and a quantity of elements of descendant nodes of the target node, determining a baking element set based on scene elements of the target node, scene elements of an ancestor node of the target node, and scene elements of the descendant nodes; and
performing lighting baking on the baking element set, to obtain lighting information of the baking element set.

16. The non-transitory readable storage media according to claim 15, wherein the target node meets the predetermined baking condition when a total of the quantity of elements of the target node and the quantity of elements of the descendant nodes of the target node falls within a preset quantity interval.

17. The non-transitory readable storage media according to claim 15, wherein the determining a baking element set based on scene elements of the target node, scene elements of an ancestor node of the target node, and scene elements of the descendant nodes comprises:
obtaining location information corresponding to the scene elements of the ancestor node of the target node;
selecting, based on the location information, a to-be-baked scene element in the scene elements of the ancestor node; and
determining the baking element set based on the to-be-baked scene element, the scene elements of the target node, and the scene elements of the descendant nodes.

18. The non-transitory readable storage media according to claim 15, wherein the determining a baking element set based on scene elements of the target node, scene elements of an ancestor node of the target node, and scene elements of the descendant nodes comprises:
obtaining location information corresponding to the scene elements of the ancestor node of the target node; and
determining, when no to-be-baked scene element is selected in the scene elements of the ancestor node based on the location information, the baking element set based on the scene elements of the target node and the scene elements of the descendant nodes.

19. The non-transitory readable storage media according to claim 15, wherein the performing scene division on the virtual scene based on the scene elements, to obtain a scene tree structure comprises:
generating an initial scene tree structure;
traversing the scene elements to obtain a to-be-added scene element, and using a root node in the initial scene tree structure as an initial node;
obtaining a node type of the initial node;
when the node type is a leaf node type, when the to-be-added scene element does not meet an element addition condition, performing node splitting on the initial node to obtain sub-nodes, to update the initial scene tree structure, selecting, in the sub-nodes obtained through splitting, a sub-node corresponding to the to-be-added scene element as an initial node, and performing the operation of obtaining a node type of the initial node;
adding, when the to-be-added scene element meets the element addition condition, the to-be-added scene element to the initial node, to update the initial scene tree structure, and performing the operation of traversing the scene elements to obtain a to-be-added scene element; and
using an updated initial scene tree structure as the scene tree structure after the traversing of the scene elements is completed.

20. The non-transitory readable storage media according to claim 15, wherein the method further comprises:
obtaining lighting information of scene elements in preset sub-scenes of the virtual scene based on the lighting information of the baking element set; and
storing the lighting information of all the scene elements in the preset sub-scenes.
